(19) United States
(12) Patent Application Publication
(10) Pub. No.: US 2026/0151995 A1
(43) Pub. Date: Jun. 4, 2026

(54) Liquid Ejecting Apparatus

(71) Applicant: SEIKO EPSON CORPORATION, Tokyo (JP)

(72) Inventors: Madoka GOI, Matsumoto (JP); Tomonori YAMADA, Shiojiri (JP); Toru KASHIMURA, Shiojiri (JP); Ryuji FUJITA, Shiojiri (JP)

(21) Appl. No.: 19/406,195

(22) Filed: Dec. 2, 2025

(30) Foreign Application Priority Data
Dec. 3, 2024 (JP) 2024-210110

(51) Int. Cl. B41J 2/045

(52) U.S. Cl. CPC B41J 2/04541; B41J 2/04548; B41J 2/0455

(57) ABSTRACT

A liquid ejecting apparatus includes an ejecting section that ejects a liquid; a detection circuit that acquires a vibration signal according to residual vibration generated in the ejecting section and outputs a signal according to the vibration signal; a switch circuit that switches whether or not to supply the vibration signal to the detection circuit; and a power supply circuit to which a first power supply signal is input and which outputs a second power supply signal to the switch circuit, in which the power supply circuit is configured to include a linear power supply circuit to which outputs a first voltage signal, and a switching power supply circuit to which outputs a second voltage signal, and output the first voltage signal or the second voltage signal as the second power supply signal.

The present application is based on, and claims priority from JP Application Serial Number 2024-210110, filed Dec. 3, 2024, the disclosure of which is hereby incorporated by reference herein in its entirety.

### BACKGROUND

### 1. Technical Field

The present disclosure relates to a liquid ejecting apparatus.

### 2. Related Art

As disclosed in JP-A-2022-098988, in a liquid ejecting apparatus that ejects a liquid in response to a pressure change in a pressure chamber, a technique for determining a state of an ejecting section based on residual vibration generated after the pressure change in the pressure chamber is known.

Meanwhile, from the viewpoint of further improving accuracy of detecting the residual vibration, the technique described in JP-A-2022-098988 is not sufficient, and there is room for improvement.

### SUMMARY

According to an aspect of the present disclosure, there is provided a liquid ejecting apparatus including: an ejecting section that ejects a liquid; a residual vibration detection circuit that acquires a residual vibration signal according to residual vibration generated in the ejecting section and outputs a residual vibration detection signal according to the residual vibration signal; a determination circuit that determines a state of the ejecting section according to the residual vibration detection signal; a first switch circuit that switches whether or not to supply the residual vibration signal to the residual vibration detection circuit; and a power supply circuit to which a first power supply signal is input and which outputs a second power supply signal to the first switch circuit, in which the power supply circuit is configured to include a linear power supply circuit to which the first power supply signal is supplied and which outputs a first voltage signal, and a switching power supply circuit to which the first power supply signal is supplied and which outputs a second voltage signal, and output the first voltage signal or the second voltage signal as the second power supply signal.

### BRIEF DESCRIPTION OF THE DRAWINGS

FIG. 1 is a diagram illustrating an example of a functional configuration of a liquid ejecting apparatus.

FIG. 2 is a diagram illustrating an example of a schematic internal structure of the liquid ejecting apparatus.

FIG. 3 is a diagram illustrating a schematic structure of an ejecting section.

FIG. 4 is a diagram illustrating an example of arrangement of nozzles.

FIG. 5 is a diagram illustrating an example of a functional configuration of a power supply unit.

FIG. 6 is a diagram illustrating an example of a functional configuration of a head unit.

FIG. 7 is a diagram illustrating an example of a configuration of a switch.

FIG. 8 is a diagram describing an example of various signals input to a coupling state designation circuit.

FIG. 9 is a diagram illustrating an example of a configuration of a waveform shaping circuit.

FIG. 10 is a diagram describing an example of various signals output by a control unit during a period in which an ejection process is being executed.

FIG. 11 is a diagram illustrating an example of a relationship between an individual designation signal and a coupling state designation signal in a period in which the ejection process is being executed.

FIG. 12 is a diagram describing an example of various signals input to a supply switching circuit of the head unit during a period in which a determination process is being executed.

FIG. 13 is a diagram illustrating an example of a relationship between the individual designation signal and the coupling state designation signal in the period in which the determination process is being executed.

FIG. 14 is a diagram illustrating an example of a relationship between the individual designation signal and the coupling state designation signal in the period in which the determination process is being executed.

FIG. 15 is a diagram describing an example of an acquisition operation of a detection potential signal based on a signal according to residual vibration generated in an ejecting section which is an inspection target.

FIG. 16 is a diagram illustrating an example of a functional configuration of a power supply unit included in a liquid ejecting apparatus according to a second embodiment.

FIG. 17 is a diagram illustrating an example of a functional configuration of a power supply unit included in a liquid ejecting apparatus according to a third embodiment.

FIG. 18 is a diagram illustrating an example of a functional configuration of a power supply unit included in a liquid ejecting apparatus according to a fourth embodiment.

### DESCRIPTION OF EMBODIMENTS

Hereinafter, appropriate embodiments of the present disclosure will be described with reference to the drawings. The drawings to be used are for convenience of description. In addition, embodiments to be described below do not inappropriately limit the contents of the present disclosure described in the claims. Moreover, not all of configurations to be described below are necessarily essential components of the present disclosure.

### 1. First Embodiment

### 1.1 Overview of Liquid Ejecting Apparatus

In the present embodiment, a liquid ejecting apparatus 1 will be described as an example of an ink jet printer that ejects inks as an example of a liquid onto a medium such as recording paper to form an image on the medium. The liquid ejecting apparatus 1 is not limited to an ink jet printer, and may be a coloring material ejecting apparatus used for manufacturing a color filter such as a liquid crystal display, an electrode material ejecting apparatus used for forming an electrode such as an organic EL display and a field emission display (FED), a bioorganic substance ejecting apparatus used for manufacturing a biochip, a stereolithography apparatus, a textile printing apparatus, and the like.

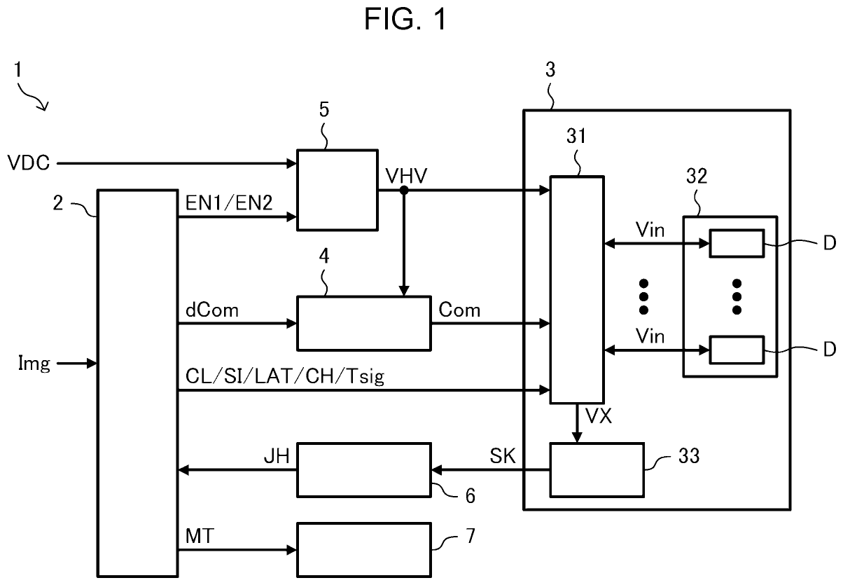

FIG. 1 is a diagram illustrating an example of a functional configuration of the liquid ejecting apparatus 1. A power supply voltage signal VDC, which is a DC voltage signal, and an image data signal Img including information on an image to be formed on a medium are input to the liquid ejecting apparatus 1 of the present embodiment. The liquid ejecting apparatus 1 forms the image on the medium in response to the image data signal Img by driving the power supply voltage signal VDC as a drive power. The liquid ejecting apparatus 1 is not limited to the configuration in which the power supply voltage signal VDC, which is a DC voltage signal, is directly input, and may be configured such that an AC/DC converter (not illustrated) that converts a commercial AC voltage into a DC voltage is provided and a DC voltage signal output by the AC/DC converter is supplied to each section of the liquid ejecting apparatus 1 as the power supply voltage signal VDC.

As illustrated in FIG. 1, the liquid ejecting apparatus 1 includes a control unit 2, a head unit 3, a drive signal output unit 4, a power supply unit 5, a determination unit 6, and a transport unit 7. Here, in the present embodiment, it is assumed that the liquid ejecting apparatus 1 includes one or a plurality of head units 3, one or a plurality of drive signal output units 4 corresponding to the one or the plurality of head units 3 on a one-to-one basis, and one or a plurality of determination units 6 corresponding to the one or the plurality of head units 3 on a one-to-one basis. Meanwhile, in the following description, for convenience, as illustrated in FIG. 1, one head unit 3 among the one or the plurality of head units 3, one drive signal output unit 4 provided to correspond to one head unit 3, and one determination unit 6 provided to correspond to one head unit 3 will be focused on and described.

The control unit 2 controls each configuration of the liquid ejecting apparatus 1 including the head unit 3, the drive signal output unit 4, the power supply unit 5, the determination unit 6, and the transport unit 7. The control unit 2 is configured with one or a plurality of central processing units (CPU). The control unit 2 may be configured to include a programmable logic device such as a field programmable gate array (FPGA) instead of the CPU or in addition to the CPU, and may be configured to further include a storage circuit. Then, the control unit 2 generates and outputs a signal for controlling an operation of each section of the liquid ejecting apparatus 1, such as output enable signals EN1 and EN2, a transport control signal MT, a clock signal CL, a print data signal SI, a latch signal LAT, a change signal CH, a period designation signal Tsig, and a drive waveform designation signal dCom, according to the input image data signal Img.

The output enable signals EN1 and EN2 output by the control unit 2 are input to the power supply unit 5. In addition, the power supply voltage signal VDC is also input to the power supply unit 5. The power supply unit 5 generates and outputs a power supply voltage signal VHV having a predetermined voltage value to be used in each section of the liquid ejecting apparatus 1, by lowering a voltage value of the power supply voltage signal VDC according to the input output enable signals EN1 and EN2. Here, the power supply voltage signal VDC is, for example, a DC voltage signal having a voltage value of 48 V, and the power supply voltage signal VHV is, for example, a DC voltage signal having a voltage value of 42 V. The power supply unit 5 may be configured to output a plurality of DC voltage signals having a voltage value different from the power supply voltage signal VHV, for example, a DC voltage signal having a voltage value of 5 V or a DC voltage signal having a voltage value of 3.3 V, in addition to the power supply voltage signal VHV. In this case, the power supply unit 5 may be configured to further include a step-down regulator that reduces the voltage value of the power supply voltage signal VHV.

The transport control signal MT output by the control unit 2 is input to the transport unit 7. The transport unit 7 controls the transport of the medium on which an ink lands in accordance with the input transport control signal MT. Therefore, a relative position between the head unit 3 and the medium is changed.

The drive waveform designation signal dCom output by the control unit 2 is input to the drive signal output unit 4. In addition, the power supply voltage signal VHV output by the power supply unit 5 is also input to the drive signal output unit 4. The drive signal output unit 4 generates and outputs a drive signal Com for driving a plurality of ejecting sections D to be described below. Specifically, the drive waveform designation signal dCom is a digital signal that defines a signal waveform of the drive signal Com output by the drive signal output unit 4, and the drive signal output unit 4 converts the input drive waveform designation signal dCom into an analog signal by a DA conversion circuit (not illustrated). The drive signal output unit 4 generates and outputs the drive signal Com obtained by amplifying a signal waveform defined by the drive waveform designation signal dCom by performing class D amplification on the converted analog signal in accordance with the voltage value of the power supply voltage signal VHV. The drive signal output unit 4 may generate and output the drive signal Com by performing class B amplification or class AB amplification on the signal waveform defined by the drive waveform designation signal dCom in accordance with the voltage value of the power supply voltage signal VHV.

The clock signal CL, the print data signal SI, the latch signal LAT, the change signal CH, and the period designation signal Tsig output by the control unit 2, the drive signal Com output by the drive signal output unit 4, and the power supply voltage signal VHV output by the power supply unit 5 are input to the head unit 3. The print data signal SI is a signal that is propagated in synchronization with the clock signal CL, and is a digital signal that designates a type of an operation of the plurality of ejecting sections D in each period defined by the latch signal LAT, the change signal CH, and the period designation signal Tsig. Specifically, the print data signal SI is information including a signal that designates whether or not to supply the drive signal Com to each of the plurality of ejecting sections D in each period defined by the latch signal LAT, the change signal CH, and the period designation signal Tsig, and therefore the operation of the corresponding ejecting section D is designated.

The head unit 3 includes a supply switching circuit 31, a recording head 32, and a detection circuit 33. Further, the recording head 32 has the plurality of ejecting sections D. Here, in the following description, the recording head 32 will be described as having M ejecting sections D. When the M ejecting sections D included in the recording head 32 are individually designated and described, the M ejecting sections D are referred to as ejecting sections D[1] to D[M]. At this time, when an m-th ejecting section D among the M ejecting sections D included in the recording head 32 is designated and described, the m-th ejecting section D may be referred to as an ejecting section D[m]. M is a natural number satisfying “M≥1”, and m is any natural number satisfying “1≤m ≤M”. Further, in the following description, when a component, a signal, or the like of the liquid ejecting apparatus 1 correspond to the ejecting section D[m] among the M ejecting sections D, the component, the signal, or the like may be given a subscript [m] in reference numeral.

The clock signal CL, the print data signal SI, the latch signal LAT, the change signal CH, the period designation signal Tsig, the drive signal Com, and the power supply voltage signal VHV are input to the supply switching circuit 31 of the head unit 3. The supply switching circuit 31 switches whether or not to supply the drive signal Com as a supply drive signal Vin to the corresponding ejecting section D based on the print data signal SI at each time defined by the latch signal LAT, the change signal CH, and the period designation signal Tsig. A piezoelectric element PZ is driven by the supply drive signal Vin being supplied to the piezoelectric element PZ (to be described below) included in the ejecting section D, and the amount of ink according to the drive amount of the piezoelectric element PZ is ejected from the ejecting section D.

In addition, the supply switching circuit 31 switches whether or not to acquire a signal corresponding to residual vibration generated in the ejecting section D as an inspection target based on the print data signal SI and to supply the signal to the detection circuit 33 as a detection potential signal VX at each time defined by the latch signal LAT, the change signal CH, and the period designation signal Tsig.

The detection circuit 33 generates a detection signal SK based on the detection potential signal VX supplied via the supply switching circuit 31, and outputs the detection signal SK to the head unit 3. Specifically, the detection circuit 33 amplifies the input detection potential signal VX, removes a noise component, and then converts the signal into a digital signal to generate the detection signal SK and output the detection signal SK from the head unit 3.

The detection signal SK output from the head unit 3 is input to the determination unit 6. The determination unit 6 determines whether or not an ink ejection state of the ejecting section D as an inspection target is normal based on the input detection signal SK, that is, whether or not the ejecting section D as an inspection target is in a normal ejection state. Specifically, the determination unit 6 reads predetermined determination threshold value information and correction value information from a storage circuit (not illustrated) including a non-volatile memory such as a read only memory (ROM) or a flash memory. The determination unit 6 corrects the input detection signal SK in accordance with the correction value information read, and compares the corrected signal with predetermined determination threshold value information. The determination unit 6 determines whether or not an ejection abnormality occurs in the ejecting section D as an inspection target according to the comparison result, and whether or not the ejecting section D as an inspection target is in the normal ejection state. The determination unit 6 generates a state determination signal JH indicating the determination result, and outputs the state determination signal JH to the control unit 2. Here, in the following description, the determination of whether or not the ejecting section D as an inspection target has an ejection abnormality, that is, the determination of whether or not the ejecting section D as an inspection target is in a normal ejection state may be referred to as simply determining the state of the ejecting section D as an inspection target.

Here, the ejection abnormality is a general term for a state in which an abnormality occurs in an ejection state of an ink from the ejecting section D as an inspection target, and a state in which the ink cannot be accurately ejected from the ejecting section D as an inspection target. Such an ejection abnormality includes, for example, a state in which the ink cannot be ejected from the ejecting section D, a state in which the amount of ink different from the ejection amount of ink defined by the drive signal Com is ejected from the ejecting section D, a state in which the ink is ejected from the ejecting section D at a speed different from an ejection speed of the ink defined by the drive signal Com, and the like.

As described above, when the ejection process of ejecting the ink to form an image corresponding to the image data signal Img on the medium is being executed, the control unit 2 generates a signal such as the print data signal SI for controlling the head unit 3 to eject the ink based on the image data signal Img, outputs the signal to the head unit 3, generates the drive waveform designation signal dCom for controlling the drive signal output unit 4 to output the drive signal Com for driving the ejecting section D to eject the ink, and outputs the drive waveform designation signal dCom to the drive signal output unit 4. At this time, the control unit 2 generates and outputs the transport control signal MT for controlling the transport unit 7. Therefore, the control unit 2 controls the presence or absence of ink ejection, the ejection amount of ink, the ink ejection time, and the like from each of the plurality of ejecting sections D while controlling the transport unit 7 to change the relative position of the medium with respect to the head unit 3. Therefore, the ink ejected from the ejecting section D lands at a desired position on the medium. As a result, the image corresponding to the image data signal Img is formed on the medium.

Further, when the determination process of determining the state of the ejecting section D is being executed, the control unit 2 generates a signal such as the print data signal SI for determining the state of the ejecting section D as an inspection target, and outputs the signal to the head unit 3, and generates the drive waveform designation signal dCom for controlling the drive signal output unit 4 to output the drive signal Com for determining the state of the ejecting section D, and outputs the drive waveform designation signal dCom to the drive signal output unit 4. Therefore, the detection potential signal VX corresponding to the ejecting section D as an inspection target is input to the detection circuit 33 via the supply switching circuit 31. The detection circuit 33 acquires the input detection potential signal VX, generates the detection signal SK according to the acquired detection potential signal VX, and outputs the detection signal SK to the determination unit 6. The determination unit 6 determines whether or not an ink ejection state of the ejecting section D as an inspection target is normal based on the input detection signal SK, that is, whether or not the ejecting section D as an inspection target is in a normal ejection state. The determination unit 6 generates the state determination signal JH according to the determination result of the state of the ejecting section D as an inspection target, and outputs the state determination signal JH to the control unit 2. Therefore, the control unit 2 can acquire the state of the ejecting section D as an inspection target, and correct various signals to be output in accordance with the acquired state of the ejecting section D as an inspection target. As a result, a quality of the image formed on the medium is improved.

As described above, the liquid ejecting apparatus 1 of the present embodiment executes various processes including the ejection process of forming the image on the medium in accordance with the image data signal Img and the determination process of determining the state of the ejecting section D that ejects the ink to the medium.

The liquid ejecting apparatus 1 may have a configuration in which the control unit 2 and the determination unit 6 are mounted on a common semiconductor device. At this time, the drive signal output unit 4 and a part or all of the transport unit 7 may be mounted on the semiconductor device. In addition, the supply switching circuit 31 and the detection circuit 33 included in the head unit 3 may be configured to be mounted on the common semiconductor device.

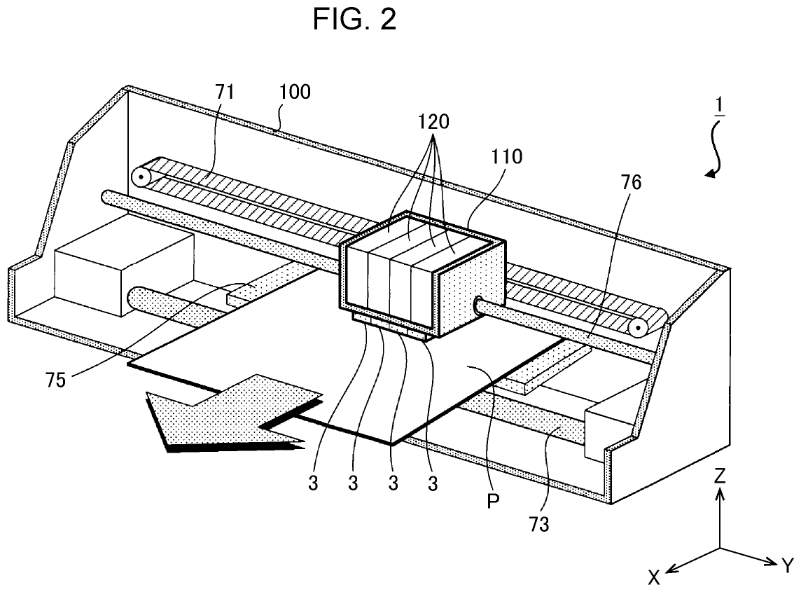

Next, an overview of a structure of the liquid ejecting apparatus 1 will be described. FIG. 2 is a diagram illustrating an example of a schematic internal structure of the liquid ejecting apparatus 1. As illustrated in FIG. 2, the liquid ejecting apparatus 1 of the present embodiment is assumed as a serial type ink jet printer. That is, when an ejection process is being executed, the liquid ejecting apparatus 1 causes the M ejecting sections D of the head unit 3 to eject an ink while transporting a medium P such as a recording paper in a sub-scanning direction and reciprocating the carriage 110 on which the head unit 3 is mounted in a main scanning direction intersecting the sub-scanning direction. At this time, the ink ejected from the M ejecting sections D lands at a desired position on the medium P. Therefore, the liquid ejecting apparatus 1 forms dots on the medium P in accordance with the image data signal Img. The liquid ejecting apparatus 1 is not limited to the serial type ink jet printer, and may be a line type ink jet printer.

In the following description, an X-axis, a Y-axis, and a Z-axis that are orthogonal to each other are used. In addition, in the following description, a starting point side of an arrow indicating a direction along the X-axis illustrated in the drawing may be referred to as a −X side, and a tip side may be referred to as a +X side. A starting point side of an arrow indicating a direction along the Y-axis illustrated in the drawing may be referred to as a −Y side, and a tip side may be referred to as a +Y side. A starting point side of an arrow indicating a direction along the Z-axis illustrated in the drawing may be referred to as a −Z side, and a tip side may be referred to as a +Z side. As illustrated in FIG. 2, in the liquid ejecting apparatus 1 of the present embodiment, the sub-scanning direction is located along the X-axis, the main scanning direction is located along the Y-axis, the medium P is transported along the X-axis such that the −X side is the upstream and the +X side is the downstream, and the carriage 110 is provided to reciprocate along the Y-axis.

As illustrated in FIG. 2, the liquid ejecting apparatus 1 includes a housing 100 and the carriage 110 which can reciprocate in the housing 100 in the Y-axis direction and on which one or a plurality of head units 3 are mounted. In addition, the carriage 110 is mounted with four ink cartridges 120 corresponding to inks of four colors of cyan, magenta, yellow, and black on a one-to-one basis. At this time, in the liquid ejecting apparatus 1 of the present embodiment, for example, a case where four head units 3 corresponding to the four ink cartridges 120 on a one-to-one basis are provided is assumed as an example.

The M ejecting sections D included in each of the four head units 3 are supplied with the ink from the corresponding ink cartridge 120. Therefore, an inside of a total of 4M ejecting sections D included in each of the four head units 3 is filled with the ink supplied from the corresponding ink cartridge 120. Then, each of the total of 4M ejecting sections D included in each of the four head units 3 ejects the ink, with which the ejecting section D is filled, toward the medium P. The ink cartridge 120 may not be mounted on the carriage 110 and may be provided at an outside of the carriage 110.

In addition, the liquid ejecting apparatus 1 of the present embodiment includes, as the transport unit 7 described above, a carriage transport mechanism 71 for reciprocating the carriage 110 along the Y-axis, a carriage guide shaft 76 that supports the carriage 110 to reciprocate in the direction along the Y-axis, a medium transport mechanism 73 for transporting the medium P, and a platen 75 provided on the −Z side of the carriage 110. When a printing process is being executed, the transport unit 7 reciprocates the carriage 110 on which the head unit 3 is mounted along the Y-axis along the carriage guide shaft 76 by the carriage transport mechanism 71, and transports the medium P from a −X side to a +X side along the X-axis on the platen 75 by the medium transport mechanism 73. Therefore, the relative position of the medium P with respect to the head unit 3 is changed, and the ink can land on the entire medium P.

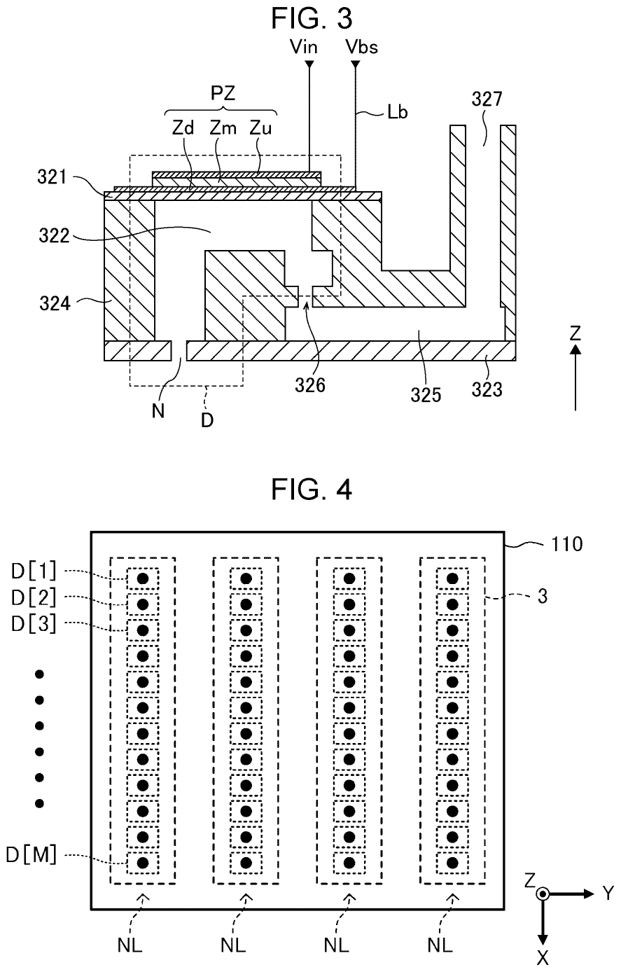

Here, an example of a structure of the ejecting section D that ejects an ink to the medium P will be described. FIG. 3 is a diagram illustrating a schematic structure of one ejecting section D. As illustrated in FIG. 3, the ejecting section D includes the piezoelectric element PZ, a cavity 322 of which an inside is filled with inks, a nozzle N communicating with the cavity 322, and a diaphragm 321. Then, in the ejecting section D, the piezoelectric element PZ is driven by supply of the supply drive signal Vin to the piezoelectric element PZ, and the ink stored in the inside of the cavity 322 is ejected from the nozzle N by the driving of the piezoelectric element PZ.

The cavity 322 is a space defined by a cavity plate 324, a nozzle plate 323 at which the nozzle N is formed, and the diaphragm 321. The cavity 322 communicates with a reservoir 325 via an ink supply port 326, and the reservoir 325 communicates with the ink cartridge 120 corresponding to the ejecting section D via the ink intake port 327. Therefore, the ink is supplied from the corresponding ink cartridge 120 to the inside of the cavity 322 via the ink intake port 327, the reservoir 325, and the ink supply port 326. Therefore, the inside of the cavity 322 is filled with the ink supplied from the corresponding ink cartridge 120.

The piezoelectric element PZ has an upper electrode Zu, a lower electrode Zd, and a piezoelectric body Zm. The piezoelectric body Zm is located between the upper electrode Zu and the lower electrode Zd. The supply drive signal Vin output by the supply switching circuit 31 is supplied to the upper electrode Zu. In addition, a reference voltage signal Vbs propagating through a wiring Lb is supplied to the lower electrode Zd. The piezoelectric body Zm has a potential difference between the upper electrode Zu and the lower electrode Zd, and is displaced on the +Z side or the −Z side along the Z-axis according to a potential difference between a voltage value of the supply drive signal Vin supplied to the upper electrode Zu and a voltage value of the reference voltage signal Vbs supplied to the lower electrode Zd. That is, the piezoelectric element PZ is driven to be displaced along the Z-axis to the +Z side or the −Z side according to the potential difference between the voltage value of the supply drive signal Vin and the voltage value of the reference voltage signal Vbs. Here, the reference voltage signal Vbs supplied to the lower electrode Zd is a signal that is a reference potential for driving the piezoelectric element PZ, and is a signal having a constant potential of 5.5 V, 6 V, a ground potential, or the like.

The lower electrode Zd is bonded to the diaphragm 321. Therefore, when the piezoelectric element PZ is driven to be displaced along the Z-axis by the supply drive signal Vin, the diaphragm 321 is also displaced along the Z-axis. An internal volume and an internal pressure of the cavity 322 are changed by the displacement of the diaphragm 321. Then, the ink with which the inside of the cavity 322 is filled is ejected from the nozzle N in response to the change in the internal volume and the internal pressure of the cavity 322. That is, the amount of ink according to the drive amount of the piezoelectric element PZ is ejected from the nozzle N of the ejecting section D. In other words, the piezoelectric element PZ ejects the amount of ink according to the displacement generated by the supply of the supply drive signal Vin corresponding to the drive signal Com, from the ejecting section D. That is, the ejecting section D includes the piezoelectric element PZ to be driven by the drive signal Com, and ejects the ink by driving the piezoelectric element PZ. In other words, the liquid ejecting apparatus 1 has the ejecting section D that ejects the ink, which is an example of a liquid.

FIG. 4 is a diagram illustrating an example of arrangement of the total of 4M ejecting sections D provided in the four head units 3 and the 4M nozzles N included in the 4M ejecting sections D. As illustrated in FIG. 4, the four head units 3 are located side by side along the Y-axis in the carriage 110. At this time, the four head units 3 are provided such that the M ejecting sections D and the nozzles N of each are located side by side along the X-axis. Specifically, the ejecting sections D[1] to D[M], which are the M ejecting sections D included in the head unit 3, are located side by side in an order of the ejecting section D[1], the ejecting section D[2], the ejecting section D[3], . . . , and the ejecting section D[M] from the −X side to the +X side along the X-axis. That is, the head unit 3 includes a nozzle row NL in which the M nozzles N included in each of the M ejecting sections D are arranged side by side from the −X side to the +X side along the X-axis. Therefore, the nozzle row NL included in each of the four head units 3 is formed in four rows along the Y-axis in the carriage 110. The ink is ejected from each of the nozzles N forming the nozzle row NL included in each of the four head units 3.

### 1.2 Configuration of Power Supply Unit

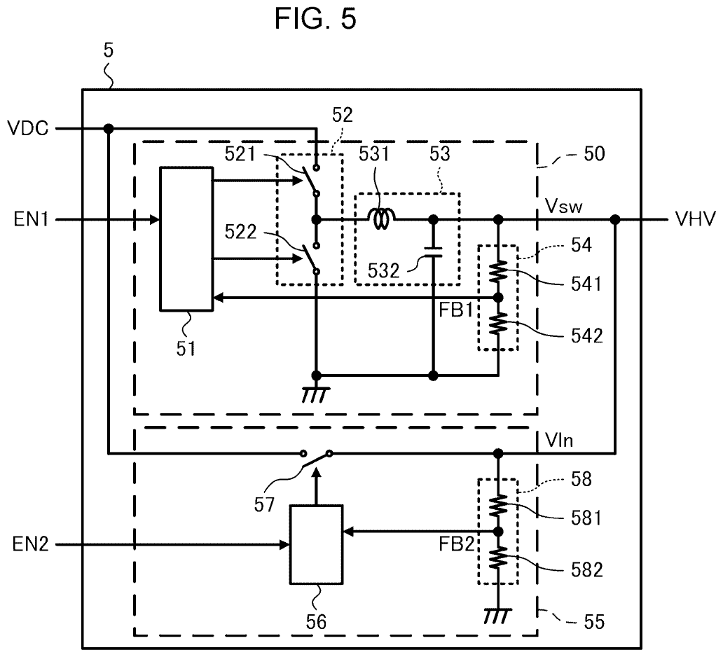

A functional configuration of the power supply unit 5 will be described. FIG. 5 is a diagram illustrating an example of a functional configuration of the power supply unit 5. As illustrated in FIG. 5, the power supply unit 5 includes a switching power supply circuit 50 and a linear power supply circuit 55. The power supply voltage signal VDC is input to the power supply unit 5, and the power supply unit 5 outputs the power supply voltage signal VHV.

The switching power supply circuit 50 includes a control circuit 51, a switching circuit 52, a smoothing circuit 53, and a feedback circuit 54. The switching circuit 52 includes transistors 521 and 522, the smoothing circuit 53 includes an inductor 531 and a capacitor 532, and the feedback circuit 54 includes resistors 541 and 542.

The output enable signal EN1 is input to the control circuit 51. When the input output enable signal EN1 includes information for enabling an operation of the switching power supply circuit 50, the control circuit 51 outputs a signal for controlling the conduction state of each of the transistors 521 and 522 included in the switching circuit 52 according to a voltage value of a feedback signal FB1, which will be described below, input from the feedback circuit 54. On the other hand, when the input output enable signal EN1 includes information for disabling the operation of the switching power supply circuit 50, the control circuit 51 outputs a signal for controlling each of the transistors 521 and 522 included in the switching circuit 52 to be non-conductive, regardless of the feedback signal FB1. Here, in the following description, a logic level of the output enable signal EN1 including the information for enabling the operation of the switching power supply circuit 50 is described as an H-level, and the logic level of the output enable signal EN1 including the information for disabling the operation of the switching power supply circuit 50 is described as an L-level. A relationship between the information on enabling or disabling the operation of the switching power supply circuit 50 and the output enable signal EN1 is not limited to this.

For example, n-channel type Metal-Oxide-Semiconductor Field-Effect Transistor (MOS-FET) is used for the transistors 521 and 522. The power supply voltage signal VDC is input to a drain terminal, which is one end of the transistor 521. A source terminal, which is the other end of the transistor 521, is electrically coupled to a drain terminal, which is one end of the transistor 522. A ground potential is supplied to a source terminal, which is the other end of the transistor 522. In addition, a signal for controlling a conduction state of each of the transistors 521 and 522 output by the control circuit 51 is input to each of a gate terminal, which is a control end for controlling a conduction state between the drain terminal and the source terminal of the transistor 521, and a gate terminal, which is a control end for controlling a conduction state between the drain terminal and the source terminal of the transistor 522. That is, the switching circuit 52 outputs a pulse signal in which a voltage value is switched between the power supply voltage signal VDC and the ground potential from a coupling point at which the source terminal of the transistor 521 and the drain terminal of the transistor 522 are electrically coupled to each other, by controlling the conduction state of each of the transistors 521 and 522 under the control of the control circuit 51.

One end of the inductor 531 is electrically coupled to the source terminal of the transistor 521 and the drain terminal of the transistor 522. The other end of the inductor 531 is electrically coupled to one end of the capacitor 532. The ground potential is supplied to the other end of the capacitor 532. That is, the smoothing circuit 53 constitutes a low pass filter including the inductor 531 and the capacitor 532. The smoothing circuit 53 smooths the pulse signal generated at a coupling point at which the source terminal of the transistor 521 and the drain terminal of the transistor 522 are electrically coupled. The signal smoothed by the smoothing circuit 53 is output as a voltage signal Vsw from the switching power supply circuit 50.

One end of the resistor 541 is electrically coupled to the other end of the inductor 531 and one end of the capacitor 532. The other end of the resistor 541 is electrically coupled to one end of the resistor 542. The ground potential is supplied to the other end of the resistor 542. A potential of a coupling point at which the other end of the resistor 541 and one end of the resistor 542 are electrically coupled to each other is input to the control circuit 51 as the feedback signal FB1. That is, the feedback circuit 54 divides a voltage value of the voltage signal Vsw output by the switching power supply circuit 50, which is a voltage value of a coupling point at which the other end of the inductor 531 and one end of the capacitor 532 are electrically coupled, by the resistors 541 and 542, and returns the divided voltage value to the control circuit 51.

The operation of the switching power supply circuit 50 configured as described above will be described. When the voltage value of the feedback signal FB1 input from the feedback circuit 54 is higher than a predetermined voltage value in a period in which the output enable signal EN1 having an H-level is input, the control circuit 51 outputs a signal that controls the drain terminal and the source terminal of the transistor 521 to be non-conductive and a signal that controls the drain terminal and the source terminal of the transistor 522 to be conductive. At this time, a voltage value of the coupling point at which the source terminal of the transistor 521 and the drain terminal of the transistor 522 are electrically coupled to each other is the ground potential. Therefore, the voltage value of the voltage signal Vsw output from the smoothing circuit 53 decreases.

In addition, when the voltage value of the feedback signal FB1 input from the feedback circuit 54 is lower than the predetermined voltage value in the period in which the output enable signal EN1 having an H-level is input, the control circuit 51 outputs a signal for controlling the drain terminal and the source terminal of the transistor 521 to be conductive and a signal for controlling the drain terminal and the source terminal of the transistor 522 to be non-conductive. At this time, the voltage value of the coupling point at which the source terminal of the transistor 521 and the drain terminal of the transistor 522 are electrically coupled to each other is the voltage value of the power supply voltage signal VDC. Therefore, the voltage value of the voltage signal Vsw output from the smoothing circuit 53 increases.

In addition, the control circuit 51 outputs a signal for controlling the drain terminal and the source terminal of the transistor 521 to be non-conductive and a signal for controlling the drain terminal and the source terminal of the transistor 522 to be non-conductive, in a period in which the output enable signal EN1 having an L-level is input. Therefore, the switching power supply circuit 50 stops the output of the voltage signal Vsw.

As described above, in the period in which the output enable signal EN1 having an H-level is input, the switching power supply circuit 50 controls the conduction states of the transistors 521 and 522 such that the voltage value of the feedback signal FB1 input from the feedback circuit 54 becomes a constant value, which is the voltage value of the voltage signal Vsw, and thus generates and outputs the voltage signal Vsw having a constant voltage value at a predetermined value. At this time, the voltage value of the voltage signal Vsw output by the switching power supply circuit 50 is a voltage value used as a power supply voltage of each configuration of the liquid ejecting apparatus 1, and is constant at 42 V. In other words, the switching power supply circuit 50 operates such that the voltage value of the output voltage signal Vsw is constant at 42 V, which is a voltage value used as the power supply voltage of each configuration of the liquid ejecting apparatus 1. The configuration of the switching power supply circuit 50 is not limited to this, and for example, a configuration in which a diode is used instead of the transistor 522 may be used.

The linear power supply circuit 55 includes a control circuit 56, a transistor 57, and a feedback circuit 58, and the feedback circuit 58 includes resistors 581 and 582.

The output enable signal EN2 is input to the control circuit 56. When the input output enable signal EN2 includes information for enabling the operation of the linear power supply circuit 55, the control circuit 56 outputs a signal for controlling a conduction state of the transistor 57 according to a voltage value of a feedback signal FB2, which will be described below, input from the feedback circuit 58. On the other hand, when the input output enable signal EN2 includes information for disabling the operation of the linear power supply circuit 55, the control circuit 56 outputs a signal for controlling the transistor 57 to be non-conductive, regardless of the feedback signal FB2. Here, in the following description, a logic level of the output enable signal EN2 including the information for enabling the operation of the linear power supply circuit 55 is described as an H-level, and the logic level of the output enable signal EN2 including the information for disabling the operation of the linear power supply circuit 55 is described as an L-level. A relationship between the information on enabling or disabling the operation of the linear power supply circuit 55 and the output enable signal EN2 is not limited to this.

For example, an npn type bipolar transistor is used as the transistor 57. The power supply voltage signal VDC is input to a collector terminal, which is one end of the transistor 57. A voltage value of an emitter terminal, which is the other end of the transistor 57, is output from the linear power supply circuit 55 as a voltage signal Vln. In addition, the signal for controlling the conduction state of the transistor 57 output by the control circuit 56 is input to a gate terminal, which is a control end for controlling a conduction state between the collector terminal and the emitter terminal of the transistor 57. That is, the transistor 57 continuously controls the amount of current output from the emitter terminal of the transistor 57 by controlling the conduction state under the control of the control circuit 56.

One end of the resistor 581 is electrically coupled to the emitter terminal of the transistor 57. The other end of the resistor 581 is electrically coupled to one end of the resistor 582. The ground potential is supplied to the other end of the resistor 582. A potential of a coupling point at which the other end of the resistor 581 and one end of the resistor 582 are electrically coupled is input to the control circuit 56 as the feedback signal FB2. That is, the feedback circuit 58 divides a voltage value of the voltage signal Vln output by the linear power supply circuit 55, which is a voltage value of the collector terminal of the transistor 57, by the resistor 581 and the resistor 582, and returns the divided voltage value to the control circuit 56.

The operation of the linear power supply circuit 55 configured as described above will be described. The control circuit 56 reduces the amount of current supplied to a base terminal of the transistor 57 when the voltage value of the feedback signal FB2 input from the feedback circuit 58 is higher than a predetermined voltage value in a period in which the output enable signal EN2 having an H-level is input. Therefore, the amount of current flowing from the collector terminal to the emitter terminal of the transistor 57 is reduced. As a result, the amount of current output from the linear power supply circuit 55 decreases, and the voltage value of the voltage signal Vln output by the linear power supply circuit 55 decreases.

Further, in the period in which the output enable signal EN2 having an H-level is input, when the voltage value of the feedback signal FB2 input from the feedback circuit 58 is lower than the predetermined voltage value, the control circuit 56 increases the amount of current supplied to the base terminal of the transistor 57. Therefore, the amount of current flowing from the collector terminal to the emitter terminal of the transistor 57 increases. As a result, the amount of current output from the linear power supply circuit 55 increases, and the voltage value of the voltage signal Vln output by the linear power supply circuit 55 increases.

Further, the control circuit 56 outputs a signal for controlling the collector terminal and the emitter terminal of the transistor 57 to be non-conductive in a period in which the output enable signal EN2 having an L-level is input. Therefore, the linear power supply circuit 55 stops the output of the voltage signal Vln.

That is, the linear power supply circuit 55 is configured to include a series regulator circuit. The linear power supply circuit 55 generates and outputs the voltage signal Vln having a constant voltage value at a predetermined value by controlling the conduction state of the transistor 57 such that the voltage value of the feedback signal FB2 input from the feedback circuit 58 becomes a constant value, which is a voltage value of the voltage signal Vln, in the period in which the output enable signal EN2 having an H-level is input. At this time, the voltage value of the voltage signal Vln output by the linear power supply circuit 55 is a voltage value used as a power supply voltage of each configuration of the liquid ejecting apparatus 1, and is constant at 42 V. In other words, the linear power supply circuit 55 operates such that the voltage value of the output voltage signal Vln is constant at 42 V, which is a voltage value used as a power supply voltage of each configuration of the liquid ejecting apparatus 1. The linear power supply circuit 55 may be configured to include a shunt regulator circuit, instead of the series regulator circuit or in addition to the series regulator circuit.

As described above, the power supply unit 5 includes the linear power supply circuit 55 to which the power supply voltage signal VDC is supplied and which outputs the voltage signal Vln which is a DC voltage of 42 V, and the switching power supply circuit 50 to which the power supply voltage signal VDC is supplied and which outputs the voltage signal Vsw which is a DC voltage of 42 V. The power supply unit 5 outputs the voltage signal Vln output by the linear power supply circuit 55 or the voltage signal Vsw output by the switching power supply circuit 50 as the power supply voltage signal VHV according to the input output enable signals EN1 and EN2.

### 1.3 Configuration of Head Unit

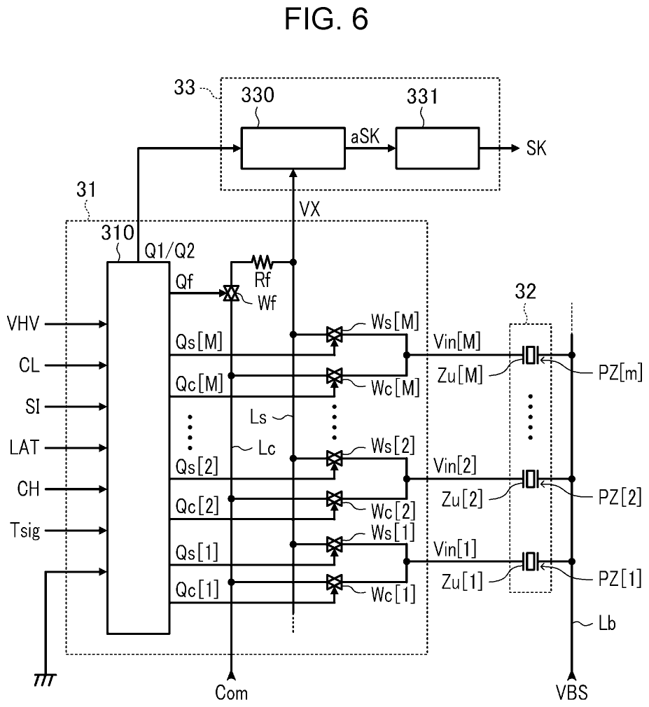

Next, a functional configuration of the head unit 3 will be described. FIG. 6 is a diagram illustrating an example of the functional configuration of the head unit 3. As described above, the head unit 3 includes the supply switching circuit 31, the recording head 32, and the detection circuit 33. In addition, in FIG. 6, in the head unit 3, a wiring Lc through which the drive signal Com propagates, the wiring Lb through which the reference voltage signal Vbs propagates, and a wiring Ls through which the detection potential signal VX propagates to the detection circuit 33 are illustrated.

The supply switching circuit 31 includes switches Wc[1] to Wc[M], switches Ws[1] to Ws[M], a switch Wf, a resistor Rf, and a coupling state designation circuit 310. The switches Wc[1] to Wc[M] and the switches Ws[1] to Ws[M] are provided to correspond to the ejecting sections D[1] to D[M], in the supply switching circuit 31. Specifically, in the supply switching circuit 31, the switch Wc[m] and the switch Ws[m] are provided to correspond to the ejecting section D[m].

The power supply voltage signal VHV, the clock signal CL, the print data signal SI, the latch signal LAT, the change signal CH, and the period designation signal Tsig are input to the head unit 3. The power supply voltage signal VHV, the clock signal CL, the print data signal SI, the latch signal LAT, the change signal CH, and the period designation signal Tsig are input to the coupling state designation circuit 310.

The coupling state designation circuit 310 generates a signal for designating a conduction state of each of the switches Wc[1] to Wc[M], the switches Ws[1] to Ws[M], and the switch Wf according to the print data signal SI propagated in synchronization with the clock signal CL, in a period defined by the input latch signal LAT, the change signal CH, and the period designation signal Tsig. Thereafter, the coupling state designation circuit 310 outputs coupling state designation signals Qc[1] to Qc[M] by level-shifting the signals for designating the conduction state of the switches Wc[1] to Wc[M] to a high-amplitude logic signal of the voltage value of the power supply voltage signal VHV, outputs coupling state designation signals Qs[1] to Qs[M] by level-shifting the signals for designating the conduction state of the switches Ws[1] to Ws[M] to the high-amplitude logic signal of the voltage value of the power supply voltage signal VHV, and outputs a coupling state designation signal Qf by level-shifting the signal for designating the conduction state of the switch Wf to the high-amplitude logic signal of the voltage value of the power supply voltage signal VHV. That is, the coupling state designation circuit 310 generates and outputs the coupling state designation signals Qc[1] to Qc[M], Qs[1] to Qs[M], and Qf in which the H-level is the power supply voltage signal VHV and the L-level is the ground potential.

The coupling state designation signals Qc[1] to Qc[M] output by the coupling state designation circuit 310 are input to control ends of the switches Wc[1] to Wc[M], the coupling state designation signals Qs[1] to Qs[M] output by the coupling state designation circuit 310 are input to control ends of the switches Ws[1] to Ws[M], and the coupling state designation signal Qf output by the coupling state designation circuit 310 is input to a control end of the switch Wf. Therefore, the conduction state of each of the switches Wc[1] to Wc[M], Ws[1] to Ws[M], and Wf is controlled. In other words, the power supply voltage signal VHV is supplied to the switches Wc[1] to Wc[M], Ws[1] to Ws[M], and Wf.

The coupling state designation circuit 310 is configured to include, for example, a register that holds the print data signal SI propagated in synchronization with the clock signal CL in correspondence with the ejecting sections D[1] to D[M], a decoder that decodes the print data signal SI held in the register to generate a signal for designating the conduction state of the switches Wc[1] to Wc[M], Ws[1] to Ws[M], and Wf, and a level shift circuit that outputs the coupling state designation signals Qc[1] to Qc[M], Qs[1] to Qs[M], Qf, and the like obtained by level-shifting the logic of the signal generated by the decoder to the high-amplitude logic signal of the voltage value of the power supply voltage signal VHV.

One end of the switch Wc[m] in the switch Wc[1] to Wc[M] is electrically coupled to the wiring Lc, and the other end is electrically coupled to the upper electrode Zu[m] of the piezoelectric element PZ[m] included in the ejecting section D[m]. The coupling state designation signal Qc[m] among the coupling state designation signals Qc[1] to Qc[M] is input to a control end of the switch Wc[m]. The switch Wc[m] switches the conduction state between one end and the other end according to a logic level of the coupling state designation signal Qc[m] input to the control end. That is, the switch Wc[m] switches a coupling state between the wiring Lc and the upper electrode Zu[m] according to the logic level of the coupling state designation signal Qc[m] input to the control end. Therefore, the switch Wc[m] switches whether or not to supply the drive signal Com propagating through the wiring Lc to the upper electrode Zu[m] of the ejecting section D[m] as the supply drive signal Vin[m] according to the coupling state designation signal Qc[m].

One end of the switch Ws[m] in the switches Ws[1] to Ws[M] is electrically coupled to the wiring Ls, and the other end is electrically coupled to the upper electrode Zu[m] of the piezoelectric element PZ[m] included in the ejecting section D[m]. The coupling state designation signal Qs[m] among the coupling state designation signals Qs[1] to Qs[M] is input to a control end of the switch Ws[m]. The switch Ws[m] switches the conduction state between one end and the other end according to the logic level of the coupling state designation signal Qs[m] input to the control end. That is, the switch Ws[m] switches a coupling state between the wiring Ls and the upper electrode Zu[m] according to a logic level of the coupling state designation signal Qs[m] input to the control end. Therefore, the switch Ws[m] switches whether or not to supply a signal generated in the upper electrode Zu[m] of the piezoelectric element PZ[m] according to residual vibration generated in the ejecting section D[m] to the wiring Ls, according to the coupling state designation signal Qs[m].

One end of the switch Wf is electrically coupled to the wiring Lc, and the other end is electrically coupled to one end of the resistor Rf. In addition, the other end of the resistor Rf is electrically coupled to the wiring Ls. That is, one end of the switch Wf is electrically coupled to the wiring Lc, and the other end is electrically coupled to the wiring Ls via the resistor Rf. The coupling state designation signal Qf is input to a control end of the switch Wf. The switch Wf switches the conduction state between one end and the other end according to the logic level of the coupling state designation signal Qf input to the control end. That is, the switch Wf switches a coupling state between the wiring Lc and the wiring Ls according to a logic level of the coupling state designation signal Qf input to the control end.

That is, the supply switching circuit 31 includes the switches Ws[1] to Ws[M] that switch whether or not to supply the detection potential signal VX to the detection circuit 33, and the switches Wc[1] to Wc[M] that switch whether or not to supply the drive signal Com to the piezoelectric elements PZ[1] to PZ[M]. The switches Ws[1] to Ws[M] switch whether or not to supply the detection potential signal VX to the detection circuit 33 based on the coupling state designation signals Qs[1] to Qs[M] according to the power supply voltage signal VHV, and the switches Wc[1] to Wc[M] switch whether or not to supply the drive signal Com to the piezoelectric elements PZ[1] to PZ[m] based on the coupling state designation signals Qc[1] to Qc[M] according to the power supply voltage signal VHV.

Each of the switches Wc[1] to Wc[M] and Ws[1] to Ws[M] can be configured by, for example, a transmission gate. Here, an example of the configuration of the transmission gates constituting the switches Wc[1] to Wc[M] and Ws[1] to Ws[M] will be described. The switches Wc[1] to Wc[M] and Ws[1] to Ws[M] have the same configuration, except that the input signals and the output signals are different. Therefore, in the following description, the switches Wc[1] to Wc[M] and Ws[1] to Ws[M] will be simply referred to as a switch W without distinction. At this time, the one end of the switch W is electrically coupled to the wiring L as the wiring Lc through which the drive signal Com propagates or a wiring L as the wiring Ls through which the detection potential signal VX propagates to the detection circuit 33, the other end of the switch W is electrically coupled to the upper electrode Zu of the piezoelectric element PZ included in the ejecting section D as the ejecting sections D[1] to D[M], and the control end of the switch W is input with the coupling state designation signals Qc[1] to Qc[M] and Qs[1] to Qs[M] as a coupling state designation signals Q.

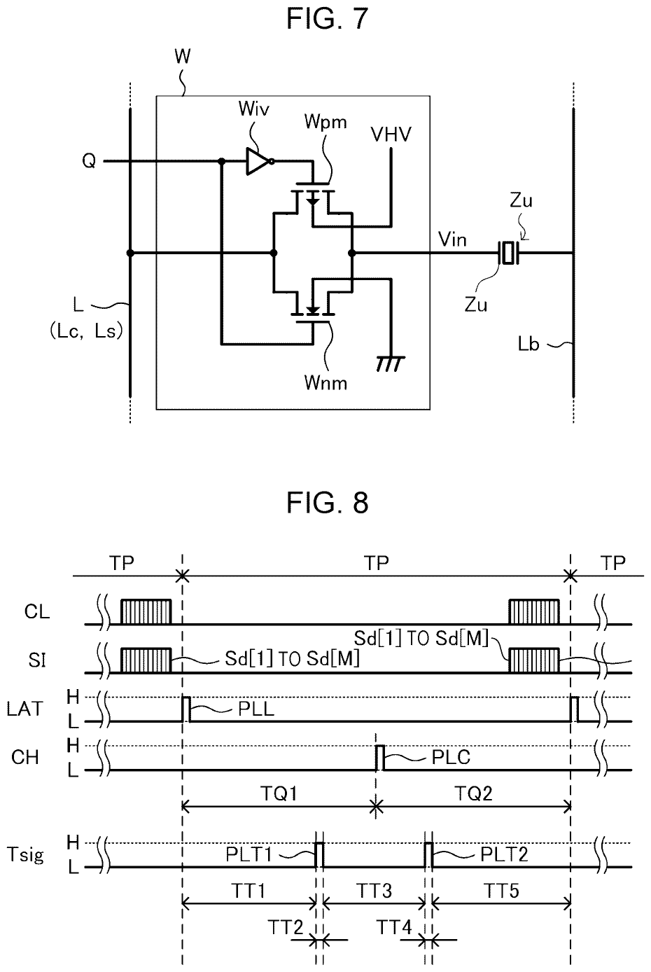

FIG. 7 is a diagram illustrating an example of a configuration of the switch W. As illustrated in FIG. 7, the switch W includes a transistor Wnm which is an n-channel type MOS-FET, a transistor Wpm which is a p-channel type MOS-FET, and an inverter Wiv.

One end of the transistor Wnm and one end of the transistor Wpm are electrically coupled to each other, and the other end of the transistor Wnm and the other end of the transistor Wpm are electrically coupled to each other. Here, one end of the transistor Wnm corresponds to a drain terminal of the switches Wc[1] to Wc[M] and corresponds to a source terminal of the switches Ws[1] to Ws[M], the other end of the transistor Wnm corresponds to a source terminal of the switches Wc[1] to Wc[M] and corresponds to a drain terminal of the switches Ws[1] to Ws[M], one end of the transistor Wpm corresponds to the source terminal of the switches Wc[1] to Wc[M] and corresponds to the drain terminal of the switches Ws[1] to Ws[M], and the other end of the transistor Wpm corresponds to the drain terminal of the switches Wc[1] to Wc[M] and corresponds to the source terminal of the switches Ws[1] to Ws[M].

A coupling point at which one end of the transistor Wnm and one end of the transistor Wpm are coupled to each other is electrically coupled to the wiring L, and a coupling point at which the other end of the transistor Wnm and the other end of the transistor Wpm are coupled to each other is electrically coupled to the upper electrode Zu of the piezoelectric element PZ. That is, the coupling point at which one end of the transistor Wnm and one end of the transistor Wpm are coupled to each other corresponds to one end of the switch W, and the coupling point at which the other end of the transistor Wnm and the other end of the transistor Wpm are coupled to each other corresponds to the other end of the switch W.

The coupling state designation signal Q is input to the gate terminal of the transistor Wnm, and a signal in which the logic level of the coupling state designation signal Q is inverted is input to the gate terminal of the transistor Wpm via the inverter Wiv. That is, conduction states of the transistor Wnm and the transistor Wpm are controlled by the coupling state designation signal Q based on the power supply voltage signal VHV.

In addition, a ground potential is supplied to a back gate terminal of the transistor Wnm, and the power supply voltage signal VHV is supplied to a back gate terminal of the transistor Wpm.

In the switch W configured as described above, when the coupling state designation signal Q having an H-level is input, one end and the other end of the transistor Wnm and one end and the other end of the transistor Wpm are controlled to be conductive, and when the coupling state designation signal Q having an L-level is input, one end and the other end of the transistor Wnm and one end and the other end of the transistor Wpm are controlled to be non-conductive. That is, the switch W is controlled to be conductive between one end and the other end when the coupling state designation signal Q having an H-level is input to the control end of the switch W, and is controlled to be non-conductive between one end and the other end when the coupling state designation signal Q having an L-level is input to the control end of the switch W.

In the switch W, the coupling state designation signal Q may be input to a gate terminal of the transistor Wpm and a signal in which a logic level of the coupling state designation signal Q is inverted may be input to a gate terminal of the transistor Wnm via the inverter Wiv. In this case, the switch W may be controlled to be conductive between one end and the other end when the coupling state designation signal Q having an L-level is input to the control end of the switch W, and may be controlled to be non-conductive between one end and the other end when the coupling state designation signal Q having an H-level is input to the control end of the switch W.

That is, the switches Wc[1] to Wc[M] include the transistors Wnm and Wpm that switch whether or not to supply the drive signal Com to the piezoelectric elements PZ[1] to PZ[M] and the power supply voltage signal VHV is supplied to the back gate terminal of the transistor Wpm, and the switches Ws[1] to Ws[M] include the transistors Wnm and Wpm that switch whether or not to supply the detection potential signal VX to the detection circuit 33 and the power supply voltage signal VHV is supplied to the back gate terminal of the transistor Wpm.

With reference to FIG. 6, the coupling state designation circuit 310 generates coupling state designation signals Q1 and Q2 in a period defined by the input latch signal LAT, the change signal CH, and the period designation signal Tsig, and outputs the coupling state designation signals Q1 and Q2 to the detection circuit 33 according to the print data signal SI propagated based on the clock signal CL.

Here, an example of various signals input to the coupling state designation circuit 310 will be described. FIG. 8 is a diagram describing an example of various signals input to the coupling state designation circuit 310. As illustrated in FIG. 8, the liquid ejecting apparatus 1 of the present embodiment defines one or a plurality of unit periods TP as operation periods, and controls driving of the ejecting section D[m] and the operation of the detection circuit 33 in each of the defined unit periods TP.

Specifically, the control unit 2 generates the latch signal LAT including a pulse PLL and outputs the latch signal LAT to the coupling state designation circuit 310. For example, the control unit 2 may generate the latch signal LAT including the pulse PLL at a time based on at least one of a transport position of the medium P transported along the sub-scanning direction and a scanning position of the carriage 110 reciprocating along the main scanning direction, by setting a logic level of the latch signal LAT to an H-level for a short time, and may output the latch signal LAT to the coupling state designation circuit 310. For example, the control unit 2 may generate the latch signal LAT including the pulse PLL by setting the logic level of the latch signal LAT to an H-level for a short time at a predetermined time interval, and output the latch signal LAT to the coupling state designation circuit 310. A period from a rising edge of the pulse PLL included in the latch signal LAT to the next rising edge of the pulse PLL corresponds to the unit period TP described above.

Further, the control unit 2 generates the change signal CH including a pulse PLC, and outputs the change signal CH to the coupling state designation circuit 310. For example, the control unit 2 generates the change signal CH including the pulse PLC by setting a logic level of the change signal CH to an H-level for a short time at a time when a predetermined time elapses from the rising edge of the pulse PLL, and outputs the change signal CH to the coupling state designation circuit 310. The pulse PLC included in the change signal CH divides the unit period TP into a control period TQ1 and a control period TQ2. Specifically, the change signal CH divides the unit period TP into the control period TQ1 which is a period from the rising edge of the pulse PLL to a rising edge of the pulse PLC, and the control period TQ2 which is a period from the rising edge of the pulse PLC to the rising edge of the pulse PLL. The number of divisions into which the unit period TP is divided by the change signal CH is not limited to two.

The control unit 2 generates the period designation signal Tsig including pulses PLT1 and PLT2, and outputs the period designation signal Tsig to the coupling state designation circuit 310. For example, the control unit 2 generates the pulse PLT1 by setting a logic level of the period designation signal Tsig to an H-level at a time when a predetermined time elapses from the rising edge of the pulse PLL, and then setting the logic level of the period designation signal Tsig to an L-level, and outputs the pulse PLT1 to the coupling state designation circuit 310, and then generates the pulse PLT2 by setting the logic level of the period designation signal Tsig to an H-level at a time when a predetermined time elapses, and then setting the logic level of the period designation signal Tsig to an L-level, and outputs the pulse PLT2 to the coupling state designation circuit 310. The pulses PLT1 and PLT2 included in the period designation signal Tsig divide the unit period TP into control periods TT1 to TT5. Specifically, in the period designation signal Tsig, the unit period TP is divided into the control period TT1, which is a period from the rising edge of the pulse PLL to the rising edge of the pulse PLT1, the control period TT2, which is a period from the rising edge of the pulse PLT1 to a falling edge of the pulse PLT1, the control period TT3, which is a period from the falling edge of the pulse PLT1 to a rising edge of the pulse PLT2, the control period TT4, which is a period from the rising edge of the pulse PLT2 to a falling edge of the pulse PLT2, and the control period TT5, which is a period from the falling edge of the pulse PLT2 to the rising edge of the pulse PLL. The number of divisions into which the unit period TP is divided by the period designation signal Tsig is not limited to five.

Further, the control unit 2 generates the print data signal SI serially including individual designation signals Sd[1] to Sd[M], and outputs the print data signal SI to the coupling state designation circuit 310. Each of the individual designation signals Sd[1] to Sd[M] is a signal including 3-bit information, and defines a driving mode of each of the ejecting sections D[1] to D[M]. Here, in the following description, the 3-bit information included in the individual designation signal Sd[m] may be referred to as bits S1, S2, and S3, and the individual designation signal Sd[m] may be expressed as Sd[m]=[S1, S2, S3]. Further, in the following description, a case where the bits S1, S2, and S3 included in the individual designation signal Sd[m] may be any of “1” and “0” may be expressed by using “*”.

Specifically, before the unit period TP to be controlled, the control unit 2 generates the print data signal SI including the individual designation signals Sd[1] to Sd[M] that define the driving mode of the ejecting sections D[1] to D[M] or the operation of the detection circuit 33 in the unit period TP to be controlled, and outputs the print data signal SI to the coupling state designation circuit 310. The print data signal SI is held in a register (not illustrated) in the coupling state designation circuit 310 in a state in which the individual designation signals Sd[1] to Sd[M] correspond to the ejecting sections D[1] to D[M], respectively. Then, when the unit period TP to be controlled arrives, the coupling state designation circuit 310 simultaneously latches the 3-bit information included in each of the held individual designation signals Sd[1] to Sd[M], and decodes the latched 3-bit information. Thus, the coupling state designation circuit 310 generates the coupling state designation signals Qc[1] to Qc[M], Qs[m] to Qs[M], Qf, Q1, and Q2 of the logic level according to the decoding content in each of the control periods TQ1 and TQ2 in the unit period TP to be controlled, or in each of the control periods TT1 to TT5, and outputs the generated signals to control ends of the corresponding switches Wc[1] to Wc[M], Ws[1] to Ws[M], Wf, W1, and W2.

Therefore, a conduction state of each of the switches Wc[1] to Wc[M], Ws[1] to Ws[M], Wf, W1, and W2 in each of the control periods TQ1 and TQ2 or each of the control periods TT1 to TT5 is controlled. As a result, the driving mode of the ejecting sections D[1] to D[M] or the operation of the detection circuit 33 in each of the control periods TQ1 and TQ2 or each of the control periods TT1 to TT5 is controlled.

With reference to FIG. 6, the detection potential signal VX propagating through the wiring Ls and the coupling state designation signals Q1 and Q2 output by the coupling state designation circuit 310 are input to the detection circuit 33. In addition, the detection circuit 33 includes a waveform shaping circuit 330 and an AD conversion circuit 331. The waveform shaping circuit 330 acquires the detection potential signal VX in accordance with the coupling state designation signals Q1 and Q2. The waveform shaping circuit 330 removes a noise from the acquired detection potential signal VX and amplifies the detection potential signal VX to shape a signal waveform of the detection potential signal VX and to output the shaped signal waveform as a detection signal aSK. The AD conversion circuit 331 converts the detection signal aSK of the analog signal output by the waveform shaping circuit 330 into a digital signal and outputs the digital signal as the detection signal SK. The detection signal SK is output from the detection circuit 33 and the head unit 3. That is, the detection circuit 33 changes a signal according to residual vibration generated in the ejecting section D into a digital signal and outputs the digital signal as the detection signal SK. That is, the detection circuit 33 acquires the detection potential signal VX corresponding to the residual vibration generated in the ejecting section D, and outputs the detection potential signal VX as the detection signal SK. At this time, the detection circuit 33 of the present embodiment includes the AD conversion circuit 331, and converts the acquired detection potential signal VX into a digital signal to output the detection signal SK of the digital signal.

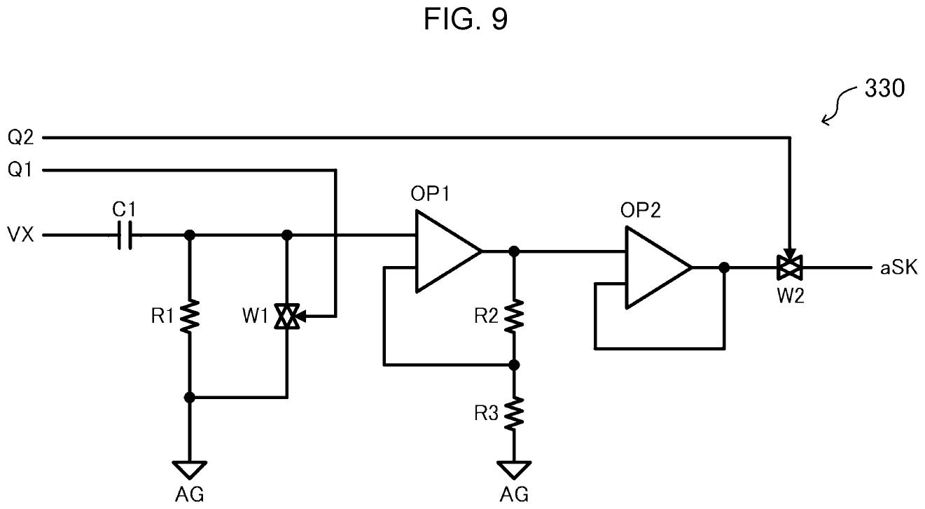

Here, an example of a configuration of the waveform shaping circuit 330 included in the detection circuit 33 will be described. FIG. 9 is a diagram illustrating an example of a configuration of the waveform shaping circuit 330. As illustrated in FIG. 9, the waveform shaping circuit 330 includes a capacitor C1, operational amplifiers OP1 and OP2, the switches W1 and W2, and resistors R1 to R3.

The detection potential signal VX output by the supply switching circuit 31 is input to one end of the capacitor C1. The other end of the capacitor C1 is electrically coupled to one end of the resistor R1 and one end of the switch W1. An analog ground AG fixed to a constant potential is supplied to the other end of the resistor R1 and the other end of the switch W1. That is, the resistor R1 and the switch W1 are coupled in parallel. The coupling state designation signal Q1 is input to the control end of the switch W1. When the coupling state designation signal Q1 having an H-level is input to the control end of the switch W1, the switch W1 becomes conductive between one end and the other end, and when the coupling state designation signal Q1 having an L-level is input to the control end of the switch W1, the switch W1 becomes non-conductive between one end and the other end. That is, the switch W1 switches a conduction state between one end of the resistor R1 and the analog ground AG. The capacitor C1, the resistor R1, and the switch W1 configured as described above function as a high-pass filter, and extract and output a signal of a predetermined high frequency component from the detection potential signal VX input during a period in which the switch W1 is controlled to be non-conductive. Here, the switch W1 may be configured by, for example, a transmission gate as illustrated in FIG. 7. In addition, the analog ground AG may be a center potential between a power supply potential on a high-potential side supplied to the head unit 3 and a power supply potential on a low-potential side.

A +side input terminal of the operational amplifier OP1 is electrically coupled to a coupling point at which the other end of the capacitor C1, one end of the resistor R1, and one end of the switch W1 are electrically coupled. That is, a signal output by the high-pass filter configured with the capacitor C1, the resistor R1, and the switch W1 is input to the +side input terminal of the operational amplifier OP1. A −side input terminal of the operational amplifier OP1 is electrically coupled to a coupling point at which one end of the resistor R2 and one end of the resistor R3 are electrically coupled. An output terminal of the operational amplifier OP1 is electrically coupled to the other end of the resistor R2. The analog ground AG is supplied to the other end of the resistor R3. That is, the operational amplifier OP1 and the resistors R2 and R3 function as a non-inverting amplifier circuit that amplifies a signal input to the +side input terminal of the operational amplifier OP1 according to resistance values of the resistors R2 and R3 and outputs the signal from the output terminal of the operational amplifier OP1. Here, the non-inverting amplifier circuit configured with the operational amplifier OP1 and the resistors R2 and R3 may be configured to output a signal obtained by superimposing a predetermined offset voltage on a signal output by the high-pass filter including the capacitor C1, the resistor R1, and the switch W1, and then amplifying the signal.

A +side input terminal of the operational amplifier OP2 is electrically coupled to the output terminal of the operational amplifier OP1. That is, a signal output by the non-inverting amplifier circuit configured with the operational amplifier OP1 and the resistors R2 and R3 is input to the +side input terminal of the operational amplifier OP2. A −side input terminal of the operational amplifier OP2 is electrically coupled to an output terminal of the operational amplifier OP2. That is, a voltage follower circuit is configured with the operational amplifier OP2. Therefore, the operational amplifier OP2 converts an impedance of a signal output by the non-inverting amplifier circuit configured with the operational amplifier OP1 and the resistors R2 and R3, and outputs the signal.

One end of the switch W2 is electrically coupled to the output terminal of the operational amplifier OP2. A signal at the other end of the switch W2 is output as the detection signal aSK from the waveform shaping circuit 330. In addition, the coupling state designation signal Q2 is input to the control end of the switch W2. When the coupling state designation signal Q2 having an H-level is input to the control end of the switch W2, the switch W2 becomes conductive between one end and the other end, and when the coupling state designation signal Q2 having an L-level is input to the control end of the switch W2, the switch W2 becomes non-conductive between one end and the other end. The switch W2 switches whether or not to output a signal output by the operational amplifier OP2 as the detection signal aSK from the waveform shaping circuit 330 according to a logic level of the coupling state designation signal Q2 input to the control end.

As described above, the waveform shaping circuit 330 removes a noise component from the detection potential signal VX by the high-pass filter configured with the capacitor C1, the resistor R1, and the switch W1, and amplifies the signal, from which the noise component is removed, by the non-inverting amplifier circuit configured with the operational amplifier OP1, and the resistors R2 and R3. The waveform shaping circuit 330 performs impedance conversion by a voltage follower circuit configured with the operational amplifier OP2, and then outputs the detection signal aSK. At this time, the switches W1 and W2 switch whether or not the waveform shaping circuit 330 acquires and outputs the detection potential signal VX as the detection signal aSK.

The detection signal aSK output by the waveform shaping circuit 330 is input to the AD conversion circuit 331. The AD conversion circuit 331 converts the detection signal aSK into a digital signal. The converted digital signal by the AD conversion circuit 331 is output as the detection signal SK from the detection circuit 33 and the head unit 3.

In the head unit 3 of the present embodiment configured as described above, the supply switching circuit 31 controls the conduction state of the switch Wc[m] according to the print data signal SI propagated based on the clock signal CL in each of the control periods TQ1 and TQ2 or the control periods TT1 to TT5 defined by the latch signal LAT, the change signal CH, and the period designation signal Tsig, and thus switches whether or not to supply the drive signal Com propagating through the wiring Ls to the piezoelectric element PZ[m] of the ejecting section D[m] as the supply drive signal Vin[m]. Therefore, the driving mode of the ejecting section D[m] is controlled.

In addition, in the head unit 3 of the present embodiment, the supply switching circuit 31 controls the conduction state of the switch Ws[m] according to the print data signal SI propagated based on the clock signal CL in each of the control periods TQ1 and TQ2 or the control periods TT1 to TT5 defined by the latch signal LAT, the change signal CH, and the period designation signal Tsig, and thus switches whether or not to acquire a signal according to residual vibration generated in the ejecting section D[m] and to output the signal to the detection circuit 33 as the detection potential signal VX. At this time, the detection circuit 33 amplifies and shapes a signal waveform of the input detection potential signal VX, according to the conduction state of the switches W1 and W2, and outputs the signal waveform as the detection signal SK.

That is, the detection circuit 33 acquires, as the detection potential signal VX, an electromotive force generated in the piezoelectric element PZ by displacement of the piezoelectric element PZ in response to the residual vibration generated in the ejecting section D, amplifies and shapes a signal waveform of the acquired detection potential signal VX, and outputs the detection potential signal VX as the detection signal SK.

The detection signal SK output by the detection circuit 33 is input to the determination unit 6. Then, the determination unit 6 determines a state of the target ejecting section D[m] based on the input detection signal SK. That is, the liquid ejecting apparatus 1 of the present embodiment includes the determination unit 6 that determines the state of the ejecting section D, which is an inspection target, in accordance with the detection signal SK.

Here, the supply switching circuit 31 included in the head unit 3 is configured with one or a plurality of semiconductor devices. In addition, at this time, a part or all of the detection circuit 33 may be mounted in the semiconductor device together with the supply switching circuit 31.

As described above, the liquid ejecting apparatus 1 of the present embodiment includes the plurality of ejecting sections D that include the piezoelectric element PZ to which the supply drive signal Vin in accordance with the drive signal Com is supplied, and eject the inks in response to driving of the piezoelectric element PZ and output a signal according to residual vibration generated after the piezoelectric element PZ is driven, the detection circuit 33 that acquires any signal according to the residual vibration generated after the piezoelectric element PZ is driven, which is output by each of the plurality of ejecting sections D, and outputs the detection signal SK in accordance with the acquired signal, the switches Ws[1] to Ws[m] that switch whether or not to supply the signal according to the residual vibration generated after the piezoelectric element PZ is driven to the detection circuit 33, and the determination unit 6 that determines the state of the ejecting section D in response to the detection signal SK.

### 1.4 Operation of Liquid Ejecting Apparatus and Head Unit During Execution of Printing Process

An operation of the liquid ejecting apparatus 1 configured as described above will be described. As described above, the liquid ejecting apparatus 1 of the present embodiment executes an ejection process of ejecting an ink to the medium P to form an image corresponding to the image data signal Img, and a determination process of determining a state of the ejecting section D that ejects the ink to the medium P. Hereinafter, each operation of the ejection process and the determination process executed by the liquid ejecting apparatus 1 will be described.

### 1.4.1 Ejection Process

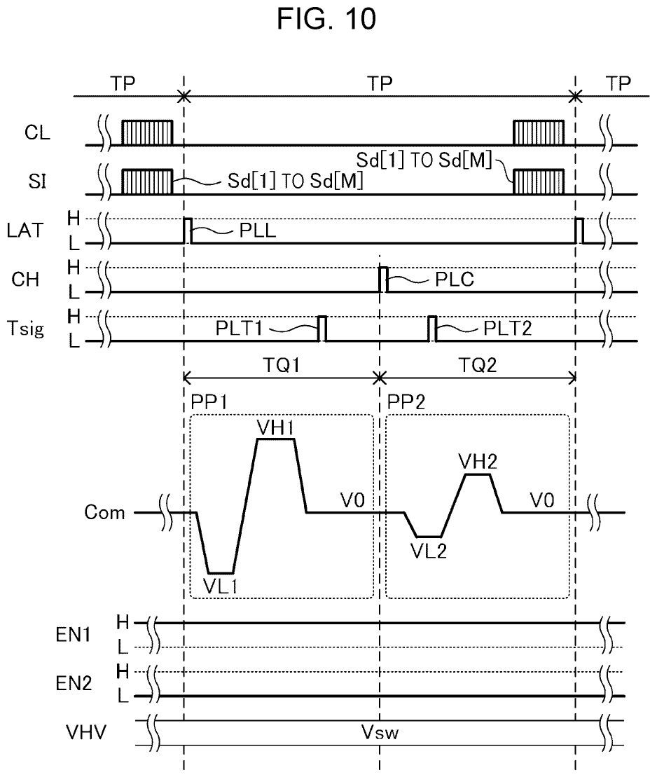

FIG. 10 is a diagram describing an example of various signals output by the control unit 2 during a period in which an ejection process is being executed.

The control unit 2 generates the drive waveform designation signal dCom that defines a signal waveform of the drive signal Com output by the drive signal output unit 4 in the period in which the ejection process is being executed, and outputs the drive waveform designation signal dCom to the drive signal output unit 4. The drive signal output unit 4 generates the drive signal Com having a signal waveform in which a drive waveform PP1 to be disposed in the control period TQ1 and a drive waveform PP2 to be disposed in the control period TQ2 are continuous for each unit period TP as illustrated in FIG. 10, in accordance with the input drive waveform designation signal dCom, and supplies the drive signal Com to the head unit 3.

The drive waveform PP1 is a signal waveform that starts with a voltage value of a reference potential V0, changes to a potential VL1 having a potential lower than the reference potential V0, changes to a potential VH1 having a potential higher than the reference potential V0, and then ends with the reference potential V0. When the drive waveform PP1 is supplied to the piezoelectric element PZ[m], the piezoelectric element PZ[m] is driven such that an ink having an ink amount ξ1 is ejected from the nozzle N[m]. That is, the drive waveform PP1 is a signal waveform for ejecting the ink having the ink amount ξ1 from the nozzle N[m].

The drive waveform PP2 is a signal waveform that starts with a voltage value of the reference potential V0, changes to a potential VL2 having a potential lower than the reference potential V0, changes to a potential VH2 having a potential higher than the reference potential V0, and then ends with the reference potential V0. When the drive waveform PP2 is supplied to the piezoelectric element PZ[m], the piezoelectric element PZ[m] is driven such that the ink having an ink amount ξ2 is ejected from the nozzle N[m]. That is, the drive waveform PP2 is a signal waveform for ejecting the ink having the ink amount ξ2 from the nozzle N[m].

Here, in the liquid ejecting apparatus 1 of the present embodiment, multi-gradation dots are formed on the medium P by selecting to form any one of a large dot, a medium dot smaller than the large dot, or a small dot smaller than the medium dot, or not to form the dots, for each unit period TP in the period in which the ejection process is being executed. That is, the liquid ejecting apparatus 1 of the present embodiment selects whether to eject an amount of ink corresponding to the large dot, an amount of ink corresponding to the medium dot, or an amount of ink corresponding to the small dot, or not to eject the inks, from the ejecting section D[m] for each unit period TP in the period in which the ejection process is being executed. At this time, the liquid ejecting apparatus 1 of the present embodiment is described such that the ink amount ξ1 ejected from the ejecting section D[m] when the drive waveform PP1 is supplied to the piezoelectric element PZ[m] is an ink amount corresponding to the medium dot, the ink amount ξ2 ejected from the ejecting section D[m] when the drive waveform PP2 is supplied to the piezoelectric element PZ[m] is smaller than the ink amount ξ1 and is an ink amount corresponding to the small dot, and a total amount of ink amount ξ1 and ink amount ξ2 is an ink amount corresponding to the large dot.

Further, in the period in which the liquid ejecting apparatus 1 of the present embodiment executes the ejection process, the individual designation signal Sd[m] input to the coupling state designation circuit 310 defines the conduction state of the switch Wc[m] in each of the control periods TQ1 and TQ2. Therefore, whether to supply the supply drive signal Vin[m] including the drive waveform PP1 disposed in the control period TQ1 and the drive waveform PP2 disposed in the control period TQ2 to the ejecting section D[m], to supply the supply drive signal Vin[m] including the drive waveform PP1 disposed in the control period TQ1 to the ejecting section D[m], to supply the supply drive signal Vin[m] including the drive waveform PP2 disposed in the control period TQ2 to the ejecting section D[m], or to supply the supply drive signal Vin[m] including neither the drive waveform PP1 disposed in the control period TQ1 nor the drive waveform PP2 disposed in the control period TQ2 to the ejecting section D[m] is controlled, for each unit period TP. Therefore, in the unit period TP in which the ejection process is being executed by the liquid ejecting apparatus 1, whether to eject the amount of ink corresponding to the large dot, the amount of ink corresponding to the medium dot, the amount of ink corresponding to the small dot, or not to eject the ink from the ejecting section D[m] is controlled. As a result, a dot size to be formed on the medium P is controlled.

Here, an example of decoding contents of the individual designation signals Sd[1] to Sd[M] executed by the coupling state designation circuit 310 will be described in a relationship between the individual designation signals Sd[1] to Sd[M] included in the print data signal SI input to the coupling state designation circuit 310 and the coupling state designation signals Qc[1] to Qc[M] and Qs[1] to Qs[M] output by the coupling state designation circuit 310, in the period in which the liquid ejecting apparatus 1 executes the ejection process.

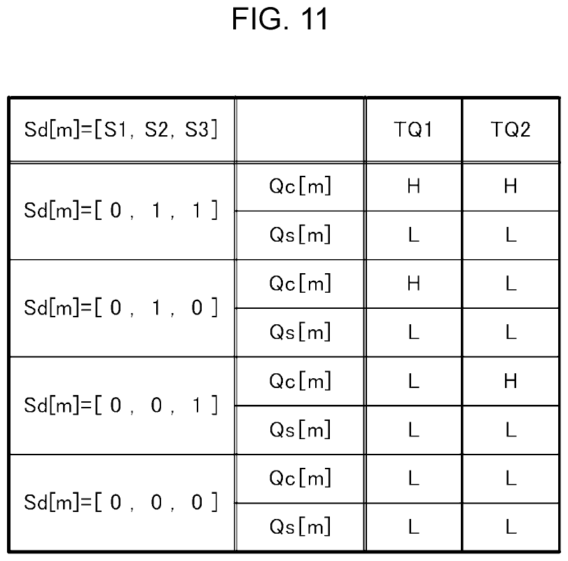

FIG. 11 is a diagram illustrating an example of a relationship between the individual designation signal Sd[m] and the coupling state designation signals Qc[m] and Qs[m] in a period in which an ejection process is being executed.

As illustrated in FIG. 11, when the individual designation signal Sd[m]=[0, 1, 1] is input to the coupling state designation circuit 310, the coupling state designation circuit 310 generates the coupling state designation signal Qc[m] that is at an H-level in the control period TQ1 and is at an H-level in the control period TQ2, and outputs the coupling state designation signal Qc[m] to the control end of the switch Wc[m]. Therefore, the switch Wc[m] is controlled to be conductive in the control period TQ1 and is controlled to be conductive in the control period TQ2. Therefore, the supply drive signal Vin[m] including the drive waveform PP1 is supplied to the piezoelectric element PZ[m] in the control period TQ1, and the supply drive signal Vin[m] including the drive waveform PP2 is supplied to the piezoelectric element PZ[m] in the control period TQ2. As a result, an ink having the ink amount ξ1 is ejected from the nozzle N[m] in the control period TQ1, and an ink having the ink amount ξ2 is ejected from the nozzle N[m] in the control period TQ2. Then, the ink of the ink amount ξ1 ejected in the control period TQ1 and the ink of the ink amount ξ2 ejected in the control period TQ2 land on the medium P and are combined with each other, so that a large dot is formed on the medium P in the unit period TP.

Further, when the individual designation signal Sd[m]=[0, 1, 0] is input to the coupling state designation circuit 310, the coupling state designation circuit 310 generates the coupling state designation signal Qc[m] that is at an H-level in the control period TQ1 and is at an L-level in the control period TQ2, and outputs the coupling state designation signal Qc[m] to the control end of the switch Wc[m]. Therefore, the switch Wc[m] is controlled to be conductive in the control period TQ1 and controlled to be non-conductive in the control period TQ2. Therefore, the supply drive signal Vin[m] including the drive waveform PP1 is supplied to the piezoelectric element PZ[m] in the control period TQ1, and the supply drive signal Vin[m] including the drive waveform PP2 is not supplied to the piezoelectric element PZ[m] in the control period TQ2. Here, in the control period TQ2 in which the supply drive signal Vin[m] including the drive waveform PP2 is not supplied to the piezoelectric element PZ[m], the reference potential V0 is held by a capacitive component of the piezoelectric element PZ[m] in the upper electrode Zu[m], which is a voltage value of a signal supplied immediately before to the upper electrode Zu[m]. That is, in the control period TQ2 in which the supply drive signal Vin[m] including the drive waveform PP2 is not supplied to the piezoelectric element PZ[m], a constant signal at the reference potential V0 is supplied to the upper electrode Zu[m]. As a result, the ink having the ink amount ξ1 is ejected from the nozzle N[m] in the control period TQ1, and the ink is not ejected in the control period TQ2. Then, the ink of the ink amount ξ1 ejected in the control period TQ1 lands on the medium P, so that a medium dot is formed on the medium P in the unit period TP.

Further, when the individual designation signal Sd[m]=[0, 0, 1] is input to the coupling state designation circuit 310, the coupling state designation circuit 310 generates the coupling state designation signal Qc[m] that is at an L-level in the control period TQ1 and is at an H-level in the control period TQ2, and outputs the coupling state designation signal Qc[m] to the control end of the switch Wc[m]. Therefore, the switch Wc[m] is controlled to be non-conductive in the control period TQ1 and is controlled to be conductive in the control period TQ2. Therefore, the supply drive signal Vin[m] including the drive waveform PP1 is not supplied to the piezoelectric element PZ[m] in the control period TQ1, and the supply drive signal Vin[m] including the drive waveform PP2 is supplied to the piezoelectric element PZ[m] in the control period TQ2. Here, in the control period TQ1 in which the supply drive signal Vin[m] including the drive waveform PP1 is not supplied to the piezoelectric element PZ[m], the reference potential V0 is held by a capacitive component of the piezoelectric element PZ[m] in the upper electrode Zu[m], which is a voltage value of a signal supplied immediately before to the upper electrode Zu[m]. That is, in the control period TQ1 in which the supply drive signal Vin[m] including the drive waveform PP1 is not supplied to the piezoelectric element PZ[m], a constant signal at the reference potential V0 is supplied to the upper electrode Zu[m]. As a result, the ink is not ejected from the nozzle N[m] in the control period TQ1, and the ink having the ink amount ξ2 is ejected from the nozzle N[m] in the control period TQ2. Then, the ink of the ink amount ξ2 ejected in the control period TQ2 lands on the medium P, so that a small dot is formed on the medium P in the unit period TP.

Further, when the individual designation signal Sd[m]=[0, 0, 0] is input to the coupling state designation circuit 310, the coupling state designation circuit 310 generates the coupling state designation signal Qc[m] that is at an H-level in the control period TQ1 and is at an L-level in the control period TQ2, and outputs the coupling state designation signal Qc[m] to the control end of the switch Wc[m]. Therefore, the switch Wc[m] is controlled to be non-conductive in the control period TQ1 and is controlled to be non-conductive in the control period TQ2. Therefore, the supply drive signal Vin[m] including the drive waveform PP1 is not supplied to the piezoelectric element PZ[m] in the control period TQ1, and the supply drive signal Vin[m] including the drive waveform PP2 is not supplied to the piezoelectric element PZ[m] in the control period TQ2. Here, in the control period TQ1 in which the supply drive signal Vin[m] including the drive waveform PP1 is not supplied to the piezoelectric element PZ[m] and the control period TQ2 in which the supply drive signal Vin[m] including the drive waveform PP2 is not supplied to the piezoelectric element PZ[m], the reference potential V0 is held by a capacitive component of the piezoelectric element PZ[m] in the upper electrode Zu[m], which is a voltage value of a signal supplied immediately before to the upper electrode Zu[m]. That is, in the control period TQ1 in which the supply drive signal Vin[m] including the drive waveform PP1 is not supplied to the piezoelectric element PZ[m], and in the control period TQ2 in which the supply drive signal Vin[m] including the drive waveform PP2 is not supplied, a constant signal at the reference potential V0 is supplied to the upper electrode Zu[m]. As a result, the ink is not ejected from the nozzle N[m] in the control period TQ1, and the ink is not ejected from the nozzle N[m] in the control period TQ2. Therefore, dots are not formed on the medium P in the unit period TP.

As described above, when the liquid ejecting apparatus 1 executes the ejection process, the coupling state designation circuit 310 outputs the coupling state designation signals Qs[1] to Qs[M] having the logic levels based on the individual designation signals Sd[1] to Sd[M], in each of the control periods TQ1 and TQ2 in the unit period TP. Therefore, the conduction states of the switches Wc[1] to Wc[m] in the control periods TQ1 and TQ2 in the unit period TP are controlled, and the ejection amount of ink to be ejected from each of the ejecting sections D[1] to D[M] in the control periods TQ1 and TQ2 in the unit period TP is controlled. That is, a dot size to be formed on the medium P in the unit period TP is controlled. Therefore, the liquid ejecting apparatus 1 can form an image corresponding to the image data signal Img on the medium P in the period in which the ejection process is being executed.

Here, as illustrated in FIG. 11, in the period in which the liquid ejecting apparatus 1 executes the ejection process, the coupling state designation circuit 310 continues to output the coupling state designation signal Qs[m] having an L-level, regardless of the input individual designation signal Sd[m]. Therefore, the switch Ws[m] is controlled to be non-conductive in the period in which the ejection process is being executed. As a result, the upper electrode Zu[m] and the wiring Ls are not electrically coupled to each other during the period in which the liquid ejecting apparatus 1 executes the ejection process. Therefore, a signal according to residual vibration generated in the ejecting section D[m] is not supplied to the detection circuit 33. Therefore, the detection circuit 33 does not acquire the detection potential signal VX in the period in which the liquid ejecting apparatus 1 executes the ejection process. Therefore, although not illustrated, in the period in which the liquid ejecting apparatus 1 executes the ejection process, the coupling state designation circuit 310 continues to output the coupling state designation signals Qf, Q1, and Q2 having an L-level.

Further, in the period in which the liquid ejecting apparatus 1 executes the ejection process, the control unit 2 generates the output enable signal EN1 having an H-level and the output enable signal EN2 having an L-level, and outputs the output enable signal EN1 and the output enable signal EN2 to the power supply unit 5. Therefore, during the period in which the liquid ejecting apparatus 1 executes the ejection process, the switching power supply circuit 50 outputs the voltage signal Vsw, and the linear power supply circuit 55 stops the output of the voltage signal Vln. Therefore, the power supply unit 5 outputs the voltage signal Vsw output by the switching power supply circuit 50 as the power supply voltage signal VHV.

Here, a loss of the transistors 521 and 522 of the switching power supply circuit 50 is smaller than a loss of the transistor 57 of the linear power supply circuit 55. Therefore, a power consumption of the switching power supply circuit 50 when the switching power supply circuit 50 generates the voltage signal Vsw from the power supply voltage signal VDC is smaller than a power consumption of the linear power supply circuit 55 when the linear power supply circuit 55 generates the voltage signal Vln from the power supply voltage signal VDC. That is, in the liquid ejecting apparatus 1 of the present embodiment, a power consumption of the power supply unit 5 can be reduced during the period in which the ejection process is being executed. In other words, the power supply unit 5 outputs the voltage signal Vsw as the power supply voltage signal VHV in the period in which the ejection process of ejecting the ink from the ejecting section D is being executed.

### 1.4.2 State Determination Process

Next, a determination process of determining a state of the ejecting section D that ejects an ink to the medium P will be described. It is known that residual vibration is generated in an ejecting section that ejects a liquid such as an ink by driving a driving element such as a piezoelectric element after the driving element is driven. The residual vibration generated in the ejecting section is so-called attenuation vibration in which an amplitude is decreased with the passage of time, and waveform information such as the amplitude, an amplitude attenuation factor, a period, and a frequency of the attenuation vibration is changed depending on a state of the ejecting section. For example, when a viscosity of the liquid stored in the ejecting section is changed, the amplitude of the residual vibration generated in the ejecting section or the amplitude attenuation factor is changed. When air bubbles are mixed into an inside of the ejecting section, for example, the frequency of the residual vibration generated in the ejecting section is increased.

In the liquid ejecting apparatus 1 of the present embodiment, in the determination process of determining the state of the ejecting section D that ejects the ink to the medium P, the supply switching circuit 31 included in the head unit 3 acquires a signal according to the residual vibration generated in the ejecting section D[m] as an inspection target and outputs the signal to the detection circuit 33 as the detection potential signal VX, and the detection circuit 33 generates the detection signal SK by shaping a signal waveform of the input detection potential signal VX. The determination unit 6 calculates waveform information such as the amplitude, the period, and the frequency of the detection potential signal VX based on the input detection signal SK, and calculates waveform information such as the amplitude, the period, and the frequency of the residual vibration generated in the ejecting section D[m] as an inspection target based on the calculated waveform information. The determination unit 6 determines the state of the ejecting section D[m] as an inspection target based on the calculated waveform information. Thereafter, the determination unit 6 generates the state determination signal JH indicating the determination result, and outputs the state determination signal JH to the control unit 2. Therefore, the control unit 2 can acquire the state of the ejecting section D[m] as an inspection target, correct the various signals to be output in accordance with the acquired state of the ejecting section D[m] as an inspection target, or notify a user of the state of the ejecting section D[m] as an inspection target.

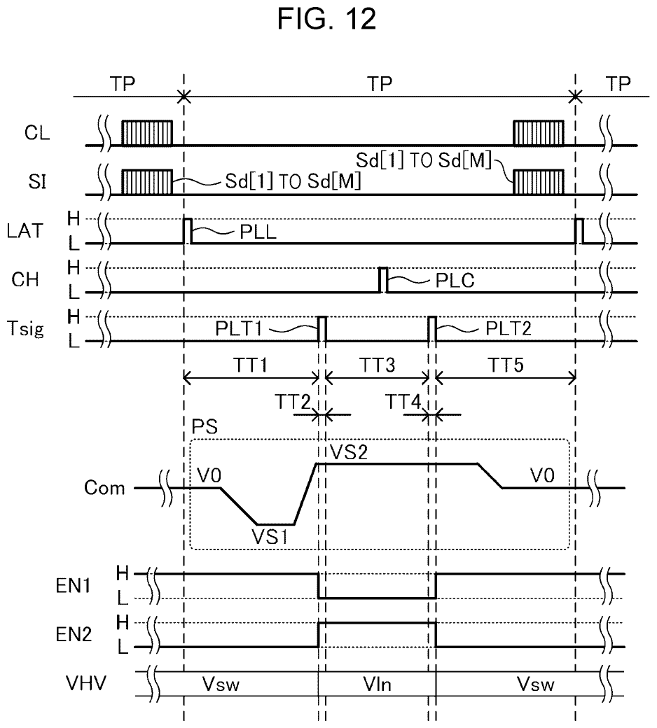

FIG. 12 is a diagram describing an example of various signals input to the supply switching circuit 31 of the head unit 3 during a period in which a determination process is being executed.

The control unit 2 generates the drive waveform designation signal dCom that defines a signal waveform of the drive signal Com output by the drive signal output unit 4 in the period in which the determination process is being executed, and outputs the drive waveform designation signal dCom to the drive signal output unit 4. The drive signal output unit 4 generates the drive signal Com including a drive waveform PS for each unit period TP as illustrated in FIG. 12, in accordance with the input drive waveform designation signal dCom, and supplies the drive signal Com to the head unit 3.

The drive waveform PS is a signal waveform in which a voltage value starts at the reference potential V0, changes to the potential VS1 having a potential lower than the reference potential V0, and is at a potential VS2 having a potential higher than the reference potential V0 in the control period TT1, maintains the potential VS2 in the control periods TT2, TT3, and TT4, and ends at the reference potential V0 in the control period TT5. When the drive waveform PS is supplied to the piezoelectric element PZ[m], the piezoelectric element PZ[m] is driven such that an ink is not ejected from the nozzle N[m], and predetermined residual vibration is generated in the ejecting section D[m] at a time when a voltage value of the drive signal Com is at the potential VS2 after the piezoelectric element PZ[m] is driven. That is, the drive waveform PS is a signal waveform for driving the piezoelectric element PZ[m] such that the ink is not ejected from the nozzle N[m] and predetermined residual vibration is generated in the ejecting section D[m], and when the drive waveform PS is supplied, the piezoelectric element PZ[m] is driven such that the ink is not ejected from the ejecting section D[m] and the residual vibration is generated.

In the period in which the liquid ejecting apparatus 1 executes the determination process, the coupling state designation circuit 310 controls the conduction states of the switches Wc[1] to Wc[M], Ws[1] to Ws[M], Wf, W1, and W2 based on the individual designation signals Sd[1] to Sd[M] included in the print data signal SI in each of the control periods TT1 to TT5, and supplies the supply drive signal Vin[m] including the drive waveform PS to the ejecting section D[m] as an inspection target, and acquires a signal according to residual vibration generated in the ejecting section D[m] as an inspection target due to the supply of the supply drive signal Vin[m] including the drive waveform PS, and outputs the acquired signal to the detection circuit 33 as the detection potential signal VX. The detection circuit 33 generates the detection signal SK by shaping a signal waveform of the input detection potential signal VX, and the determination unit 6 determines a state of the ejecting section D[m] as an inspection target based on the detection signal SK.

Here, an example of a decoding content of the individual designation signals Sd[1] to Sd[M] executed by the coupling state designation circuit 310, in a period in which the liquid ejecting apparatus 1 executes a determination process, in a relationship between the individual designation signals Sd[1] to Sd[M] included in the print data signal SI input to the coupling state designation circuit 310 and the coupling state designation signals Qc[1] to Qc[M], Qs[1] to Qs[M], Qf, Q1, and Q2 output by the coupling state designation circuit 310 in the period in which the determination process is being executed will be described.

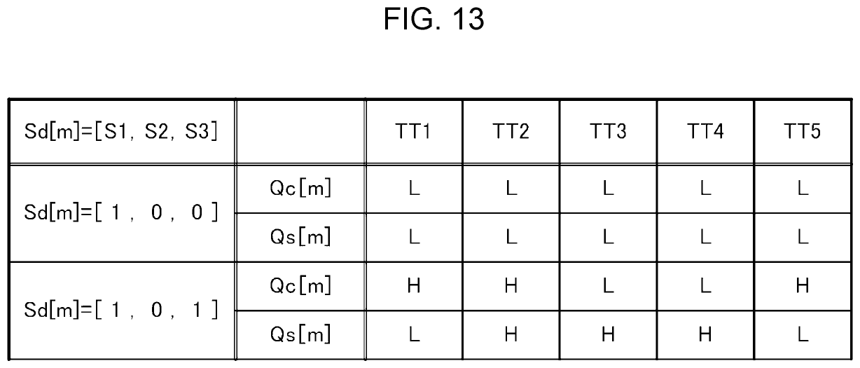

FIG. 13 is a diagram illustrating an example of a relationship between the individual designation signal Sd[m] and the coupling state designation signals Qc[m] and Qs[m] in a period in which a determination process is being executed. Here, the liquid ejecting apparatus 1 of the present embodiment will be described such that in the period in which the determination process is being executed, the control unit 2 outputs the individual designation signal Sd[m]=[1, 0, 0] to the coupling state designation circuit 310 when the ejecting section D[m] is not an inspection target, and outputs the individual designation signal Sd[m]=[1, 0, 1] to the coupling state designation circuit 310 when the ejecting section D[m] is the inspection target.

As illustrated in FIG. 13, when the individual designation signal Sd[m]=[1, 0, 0] is input to the coupling state designation circuit 310, the coupling state designation circuit 310 generates the coupling state designation signal Qc[m] that is at an L-level in the control periods TT1 to TT5 and outputs the coupling state designation signal Qc[m] to the control end of the switch Wc[m], and generates the coupling state designation signal Qs[m] that is at an L-level in the control periods TT1 to TT5 and outputs the coupling state designation signal Qs[m] to the control end of the switch Ws[m]. Therefore, in the control periods TT1 to TT5, the switch Wc[m] is controlled to be non-conductive, and the switch Ws[m] is controlled to be non-conductive. At this time, the supply drive signal Vin[m] corresponding to the drive signal Com is not supplied to the piezoelectric element PZ[m] of the ejecting section D[m] that is not an inspection target. Therefore, residual vibration is not generated in the ejecting section D[m] that is not an inspection target, and in this case, even when a potential of the upper electrode Zu[m] of the piezoelectric element PZ[m] included in the ejecting section D[m] that is not an inspection target is changed, a signal according to the change in the potential is not supplied to the wiring Ls. Therefore, the determination on the state of the ejecting section D[m] that is not the inspection target is not executed.

Further, when the individual designation signal Sd[m]=[1, 0, 1] is input to the coupling state designation circuit 310, the coupling state designation circuit 310 generates the coupling state designation signal Qc[m] that is at an H-level in the control periods TT1, TT2, and TT5 and is at an L-level in the control periods TT3 and TT4 and outputs the coupling state designation signal Qc[m] to the control end of the switch Wc[m], and generates the coupling state designation signal Qs[m] that is at an H-level in the control periods TT2 to TT4 and is at an L-level in the control periods TT1 and TT5 and outputs the coupling state designation signal Qs[m] to the control end of the switch Ws[m]. Therefore, the switch Wc[m] is controlled to be conductive in the control periods TT1, TT2, and TT5 and is controlled to be non-conductive in the control periods TT3 and TT4, and the switch Ws[m] is controlled to be conductive in the control periods TT2 to TT4 and is controlled to be non-conductive in the control periods TT1 and TT5.

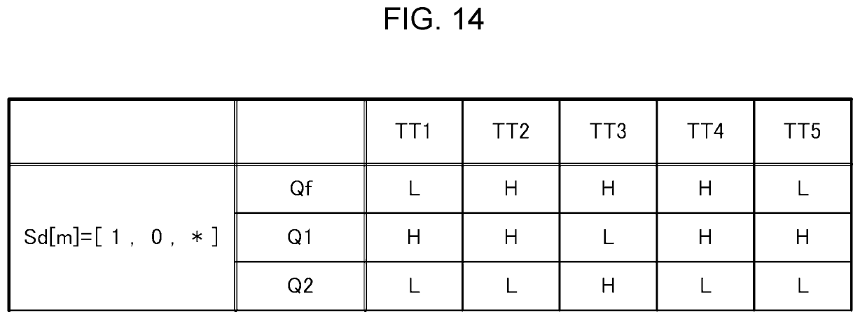

FIG. 14 is a diagram illustrating an example of a relationship between the individual designation signal Sd[m] and the coupling state designation signals Qf, Q1, and Q2 in the period in which the determination process is being executed. Here, in the period in which the determination process is being executed, the coupling state designation circuit 310 outputs the coupling state designation signals Qf, Q1, and Q2 having the same logic level in each of the control periods TT1 to TT5 when the individual designation signal Sd[m]=[1, 0, 0] is input and when the individual designation signal Sd[m]=[1, 0, 1] is input. Therefore, in FIG. 14, the individual designation signal Sd[m]=[1, 0, 0] and the individual designation signal Sd[m]=[1, 0, 1] are collectively illustrated as the individual designation signal Sd[m]=[1, 0, *].

As illustrated in FIG. 14, when the individual designation signal Sd[m]=[1, 0, *] is input to the coupling state designation circuit 310, the coupling state designation circuit 310 generates the coupling state designation signal Qf that is at an H-level in the control periods TT2 to TT4 and is at an L-level in the control periods TT1 and TT5 and outputs the coupling state designation signal Qf to the control end of the switch Wf, generates the coupling state designation signal Q1 that is at an H-level in the control periods TT1, TT2, TT4, and TT5 and is at an L-level in the control period TT3 and outputs the coupling state designation signal Q1 to the control end of the switch W1, and generates the coupling state designation signal Q2 that is at an H-level in the control period TT3 and is at an L-level in the control periods TT1, TT2, TT4, and TT5 and outputs the coupling state designation signal Q2 to the control end of the switch W2. Therefore, the switch Wf is controlled to be conductive in the control periods TT2 to TT4 and controlled to be non-conductive in the control periods TT1 and TT5, the switch W1 is controlled to be conductive in the control periods TT1, TT2, TT4, and TT5 and controlled to be non-conductive in the control period TT3, and the switch W2 is controlled to be conductive in the control period TT3 and controlled to be non-conductive in the control periods TT1, TT2, TT4, and TT5.

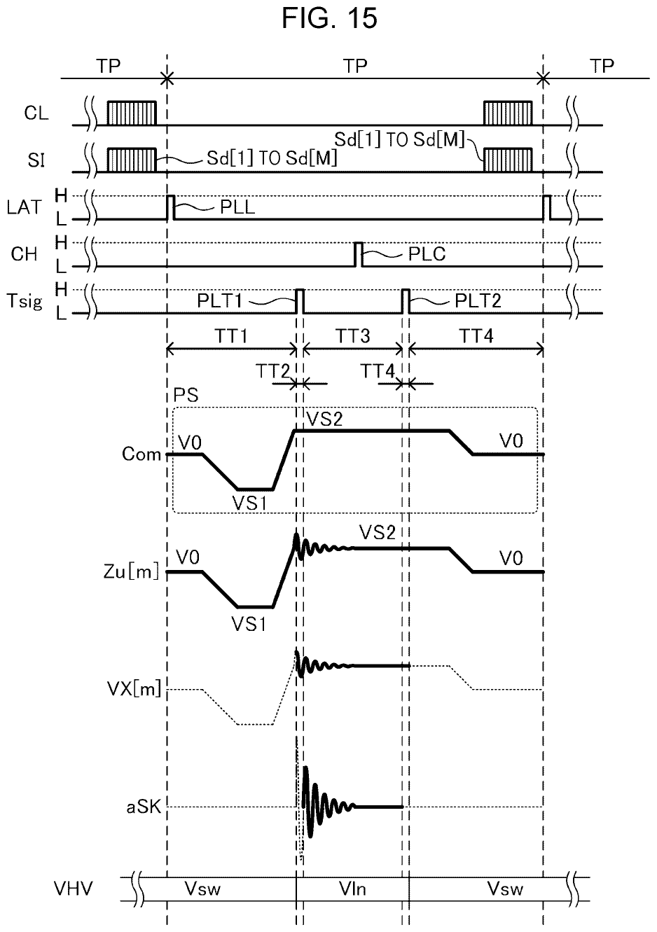

Here, an operation of the liquid ejecting apparatus 1 when the individual designation signal Sd[m]=[1, 0, 1] is input to the coupling state designation circuit 310 will be described as an example of an acquisition operation in which the detection circuit 33 acquires the detection potential signal VX based on a signal according to residual vibration generated in the ejecting section D[m] as an inspection target. FIG. 15 is a diagram describing an example of an acquisition operation of the detection potential signal VX based on the signal according to the residual vibration generated in the ejecting section D[m] as an inspection target.

As illustrated in FIG. 15, for each unit period TP in the period in which the determination process is being executed, the coupling state designation circuit 310 is supplied with the drive signal Com including the drive waveform PS in which the voltage value starts at the reference potential V0, changes to the potential VS1 having a potential lower than the reference potential V0, and is at the potential VS2 having a potential higher than the reference potential V0 in the control period TT1, maintains the potential VS2 in the control periods TT2 to TT4, and ends at the reference potential V0 in the control period TT5.

Then, in the period in which the determination process is being executed, the control unit 2 outputs the individual designation signal Sd[m]=[1, 0, 1] corresponding to the ejecting section D[m] as an inspection target to the coupling state designation circuit 310. At this time, the ejecting sections D[1] to D[m−1] and D[m+1] to D[M] are not the inspection targets. That is, the control unit 2 outputs the individual designation signals Sd[1] to Sd[m−1], and Sd[m+1] to Sd[M]=[1, 0, 0] to the coupling state designation circuit 310.

When the print data signal SI including the individual designation signal Sd[m]=[1, 0, 1] and the individual designation signals Sd[1] to Sd[m−1], Sd[m+1] to Sd[M]=[1, 0, 0] is input to the coupling state designation circuit 310, the switch Wc[m] is controlled to be conductive and the switches Wc[1] to Wc[m−1] and Wc[m+1] to Wc[M] are controlled to be non-conductive in the control periods TT1 and TT2. Therefore, in the control periods TT1 and TT2, the upper electrode Zu[m] is supplied with the supply drive signal Vin[m] in which a voltage value starts with the reference potential V0 and changes to the potential VS1 having a potential lower than the reference potential V0, and then is at the potential VS2 having a potential higher than the reference potential V0 and maintains the potential VS2, and the reference potential V0 is held at the upper electrodes Zu[1] to Zu[m−1] and Zu[m+1] to Zu[M]. At this time, in the ejecting section D[m] as an inspection target, residual vibration is generated at a time at which a voltage value of the supply drive signal Vin[m] supplied is constant at the potential VS2. Then, the piezoelectric body Zm[m] is deformed according to the residual vibration generated in the ejecting section D[m] as an inspection target, and an electromotive force corresponding to the deformation of the piezoelectric body Zm[m] is generated in the upper electrode Zu[m]. That is, a signal according to the residual vibration generated in the ejecting section D[m] as an inspection target is generated in the upper electrode Zu[m] of the piezoelectric element PZ[m] included in the ejecting section D[m] as an inspection target. In other words, the ejecting section D[m] includes the piezoelectric element PZ[m] that outputs a signal according to the electromotive force according to the residual vibration.

In the control period TT2, the switch Ws[m] is controlled to be conductive, the switches Ws[1] to Ws[m−1] and Ws[m+1] to Ws[M] are controlled to be non-conductive, and the switch Wf is controlled to be conductive. Therefore, the signal according to the residual vibration generated in the ejecting section D[m] as an inspection target propagates through the wiring Ls as the detection potential signal VX. At this time, the switch W1 is controlled to be conductive, and the switch W2 is controlled to be non-conductive. Therefore, in the control period TT2, the waveform shaping circuit 330 included in the detection circuit 33 does not acquire the detection potential signal VX propagating through the wiring Ls, and thus, does not output the detection signal aSK corresponding to the detection potential signal VX.

In the control period TT3, the switch W1 is controlled to be non-conductive and the switch W2 is controlled to be conductive. Therefore, the waveform shaping circuit 330 included in the detection circuit 33 acquires the detection potential signal VX that is the signal according to the residual vibration generated in the ejecting section D[m] as an inspection target and propagates through the wiring Ls, shapes a signal waveform of the acquired detection potential signal VX, and outputs the shaped signal waveform as the detection signal aSK. The detection signal aSK output by the waveform shaping circuit 330 is converted into a digital signal in the AD conversion circuit 331, and then is input to the determination unit 6 as the detection signal SK.

The determination unit 6 calculates waveform information such as an amplitude, a period, and a frequency of the residual vibration generated in the ejecting section D[m] as an inspection target based on the input detection signal SK, which is waveform information such as an amplitude, a period, and a frequency of the detection potential signal VX. Then, the determination unit 6 determines a state of the ejecting section D[m] as an inspection target based on the calculated waveform information, and outputs a determination result as the state determination signal JH to the control unit 2.

In the subsequent control period TT4, the switch W1 is controlled to be conductive and the switch W2 is controlled to be non-conductive, so that the waveform shaping circuit 330 stops acquiring the detection potential signal VX propagating through the wiring Ls and outputting the detection signal aSK. In the control period TT5, the switch Wc[m] is controlled to be conductive and the switch Ws[m] is controlled to be non-conductive. Therefore, the supply of the signal generated in the upper electrode Zu[m] to the wiring Ls is stopped, and the supply drive signal Vin[m] of the reference potential V0 is supplied to the upper electrode Zu[m] of the piezoelectric element PZ[m] included in the ejecting section D[m] as an inspection target. Therefore, a potential of the upper electrode Zu[m] of the piezoelectric element PZ[m] included in the ejecting section D[m] as an inspection target is controlled to the reference potential V0.

As illustrated in FIG. 12, in the control periods TT1 and TT5 during the period in which the liquid ejecting apparatus 1 executes the determination process, the control unit 2 generates the output enable signal EN1 having an H-level and the output enable signal EN2 having an L-level, and outputs the output enable signal EN1 and the output enable signal EN2 to the power supply unit 5. Therefore, in the control periods TT1 and TT5 within the period in which the liquid ejecting apparatus 1 executes the determination process, the switching power supply circuit 50 outputs the voltage signal Vsw, and the linear power supply circuit 55 stops the output of the voltage signal Vln. Therefore, in the control periods TT1 and TT5 within the period in which the liquid ejecting apparatus 1 executes the determination process, the power supply unit 5 outputs the voltage signal Vsw as the power supply voltage signal VHV.

In addition, in the control periods TT2 to TT4 during the period in which the liquid ejecting apparatus 1 executes the determination process, the control unit 2 generates the output enable signal EN1 having an L-level and the output enable signal EN2 having an H-level, and outputs the output enable signal EN1 and the output enable signal EN2 to the power supply unit 5. Therefore, in the control periods TT2 to TT4 within the period in which the liquid ejecting apparatus 1 executes the determination process, the switching power supply circuit 50 stops the output of the voltage signal Vsw, and the linear power supply circuit 55 outputs the voltage signal Vln. Therefore, in the control periods TT2 to TT4 during the period in which the liquid ejecting apparatus 1 executes the determination process, the power supply unit 5 outputs the voltage signal Vln as the power supply voltage signal VHV. That is, in the control period TT3 in which the detection circuit 33 acquires a signal corresponding to the residual vibration generated in the ejecting section D[m] as an inspection target as the detection potential signal VX, the power supply unit 5 outputs the voltage signal Vln output by the linear power supply circuit 55 as the power supply voltage signal VHV. In other words, in the period in which the determination process is being executed, and preferably in the control periods TT2 to TT4 in the period in which the determination process is being executed, the power supply unit 5 outputs the voltage signal Vln as the power supply voltage signal VHV.

The switching power supply circuit 50 generates a pulse signal in which a voltage value changes between the power supply voltage signal VHV and the ground potential by the operation of the transistors 521 and 522 included in the switching circuit 52, and the smoothing circuit 53 smooths the pulse signal to generate the voltage signal Vsw. Therefore, as compared with the linear power supply circuit 55, while the switching power supply circuit 50 can reduce a power consumption, a ripple voltage is superimposed on the output voltage signal Vsw. Therefore, in a period in which the power supply unit 5 outputs the voltage signal Vsw as the power supply voltage signal VHV, the ripple voltage superimposed on the voltage signal Vsw may be superimposed on the drive signal Com which propagates through the wiring Lc or the detection potential signal VX which is a signal corresponding to the residual vibration generated in the ejecting section D[m] as an inspection target, which propagates through the wiring Ls, via the wiring pattern, a parasitic capacitance between the gate terminal, or the like, the drain terminal, and the source terminal of the transistors Wnm and Wpm included in each of the switches Wc[1] to Wc[M], Ws[1] to Ws[M], and Wf, and a parasitic capacitance between the back gate terminal, the drain terminal, and the source terminal of the transistors Wpm included in each of the switches Wc[1] to Wc[M], Ws[1] to Ws[M], and Wf.

A voltage amplitude of the ripple voltage superimposed on the voltage signal Vsw output by the switching power supply circuit 50 is generally about several tens of mV to 100 mV, and is sufficiently smaller than a voltage value of the drive signal Com having a voltage amplitude of several tens of V. Therefore, even when the ripple voltage superimposed on the voltage signal Vsw output by the switching power supply circuit 50 is superimposed on the drive signal Com, the ripple voltage does not have a great influence on the ejection of the ink from the ejecting section D[m].

On the other hand, a voltage amplitude of the signal corresponding to the residual vibration generated in the ejecting section D[m] as an inspection target, that is, a voltage amplitude of the detection potential signal VX is approximately several tens of mV to 100 mV. Therefore, when the ripple voltage superimposed on the voltage signal Vsw is superimposed on the signal corresponding to the residual vibration generated in the ejecting section D[m] as an inspection target, that is, the detection potential signal VX, waveform information such as an amplitude, an amplitude attenuation factor, a period, and a frequency of the detection potential signal VX is greatly changed. That is, waveform accuracy of the signal waveform of the detection potential signal VX input to the detection circuit 33 is lowered. As a result, accuracy of determining the state of the ejecting section D[m] as an inspection target in the determination unit 6 is lowered.

In the liquid ejecting apparatus 1 of the present embodiment, in the period in which the signal according to the residual vibration generated in the ejecting section D[m] as an inspection target is acquired as the detection potential signal VX, the power supply unit 5 outputs the voltage signal Vln output by the linear power supply circuit 55 as the power supply voltage signal VHV for the ripple voltage not being superimposed. Therefore, the possibility that the signal accuracy of the detection potential signal VX, which is the signal according to the residual vibration generated in the ejecting section D[m] as an inspection target, is lowered is reduced. As a result, the possibility that the accuracy of determining the state of the ejecting section D[m] as an inspection target in the determination unit 6 is lowered is reduced.

Here, the detection circuit 33 is an example of a residual vibration detection circuit, the power supply unit 5 is an example of a power supply circuit, the determination unit 6 is an example of a determination circuit, the switch Ws[m] is an example of a first switch circuit, the switch Wc[m] is an example of a second switch circuit, the transistor Wpm is an example of a transistor element, and the AD conversion circuit 331 is an example of an AD conversion circuit. In addition, the power supply voltage signal VDC is an example of a first power supply signal, the power supply voltage signal VHV is an example of a second power supply signal, the voltage signal Vln is an example of a first voltage signal, the voltage signal Vsw is an example of a second voltage signal, the detection potential signal VX is an example of a residual vibration signal, the detection signal SK is an example of a residual vibration detection signal, the coupling state designation signal Qs[m] is an example of a first selection signal, and the coupling state designation signal Qc[m] is an example of a second selection signal. The period in which the determination process is being executed, and preferably in the control period TT2 to TT4 in the period in which the determination process is being executed is an example of a first period, and the period in which the ejection process of ejecting the ink from the ejecting section D is being executed is an example of a second period.

### 1.5 Operational Effects

As described above, the liquid ejecting apparatus 1 of the present embodiment includes the ejecting section D that ejects the ink, which is an example of a liquid, the detection circuit 33 that acquires the detection potential signal VX corresponding to the residual vibration generated in the ejecting section D and outputs the detection potential signal VX as the detection signal SK, the determination unit 6 that determines the state of the ejecting section D, which is an inspection target, according to the detection signal SK, the switches Ws[1] to Ws[M] that switch whether or not to supply the detection potential signal VX to the detection circuit 33, and the power supply unit 5 to which the power supply voltage signal VDC is input and which outputs the power supply voltage signal VHV to be supplied to the switches Wc[1] to Wc[M], Ws[1] to Ws[M], and Wf, the power supply unit 5 includes the linear power supply circuit 55 to which the power supply voltage signal VDC is supplied and which outputs the voltage signal Vln, which is a DC voltage of 42 V, and the switching power supply circuit 50 to which the power supply voltage signal VDC is supplied and which outputs the voltage signal Vsw, which is a DC voltage of 42 V, and outputs the voltage signal Vln output by the linear power supply circuit 55 or the voltage signal Vsw output by the switching power supply circuit 50 according to the input output enable signals EN1 and EN2, as the power supply voltage signal VHV. That is, the power supply unit 5 can select any one of the voltage signal Vsw output by the switching power supply circuit 50 having a small power consumption and the voltage signal Vln output by the linear power supply circuit 55 for the ripple voltage not occurring, and output the selected voltage signal as the power supply voltage signal VHV.

Therefore, by switching the switches Ws[1] to Ws[M], when the signal corresponding to the residual vibration having a small voltage value is supplied to the detection circuit 33 as the detection potential signal VX, the voltage signal Vln output by the linear power supply circuit 55 having a small ripple voltage can be supplied to the switches Ws[1] to Ws[M] as the power supply voltage signal VHV. As a result, the possibility that the ripple voltage, which is a voltage change generated in the power supply voltage signal VHV and can be superimposed on the power supply voltage signal VHV, is given to the signal corresponding to the residual vibration having a small voltage value and the detection potential signal VX via the switches Ws[1] to Ws[M] is reduced. Therefore, the waveform accuracy of the detection potential signal VX acquired by the detection circuit 33 and the detection signal SK output by the detection circuit 33 is improved, and the accuracy of determining the state of the ejecting section D as an inspection target in the determination unit 6 according to the detection signal SK is improved. That is, the accuracy of detecting the residual vibration generated in the ejecting section D as an inspection target is improved.

In the liquid ejecting apparatus 1 of the present embodiment, the power supply unit 5 can select any one of the voltage signal Vsw output by the switching power supply circuit 50 having a small power consumption and the voltage signal Vln output by the linear power supply circuit 55 for the ripple voltage not occurring and output the selected signal as the power supply voltage signal VHV. Therefore, the switch Ws[1] to Ws[M] includes the transistors Wnm and Wpm that switch whether or not to supply the detection potential signal VX to the detection circuit 33, and the power supply voltage signal VHV is supplied to the back gate terminal of the transistor Wpm such that the stability of the operation of the transistor Wpm is improved even when the accuracy of detecting the residual vibration generated in the ejecting section D as an inspection target can be improved.

In particular, in the liquid ejecting apparatus 1 of the present embodiment, the power supply unit 5 outputs the voltage signal Vsw as the power supply voltage signal VHV in the period in which the ejection process is being executed, and outputs the voltage signal Vln as the power supply voltage signal VHV in the period in which the determination process is being executed, and preferably, in the control periods TT2 to TT4 within the period in which the determination process is being executed. Therefore, the power supply unit 5 can optimally control the period in which the voltage signal Vln output by the linear power supply circuit 55 having a larger power consumption than the switching power supply circuit 50 is output as the power supply voltage signal VHV. As a result, both the reduction in power consumption of the liquid ejecting apparatus 1 and the improvement in the accuracy of detecting the residual vibration generated in the ejecting section D as an

### Inspection Target Can Be Achieved.

### 2. Second Embodiment

Next, a liquid ejecting apparatus 1 of a second embodiment will be described. In describing the liquid ejecting apparatus 1 of the second embodiment, the same reference numerals are given to the same configurations as those of the liquid ejecting apparatus 1 of the first embodiment, and the description thereof will be simplified or omitted.

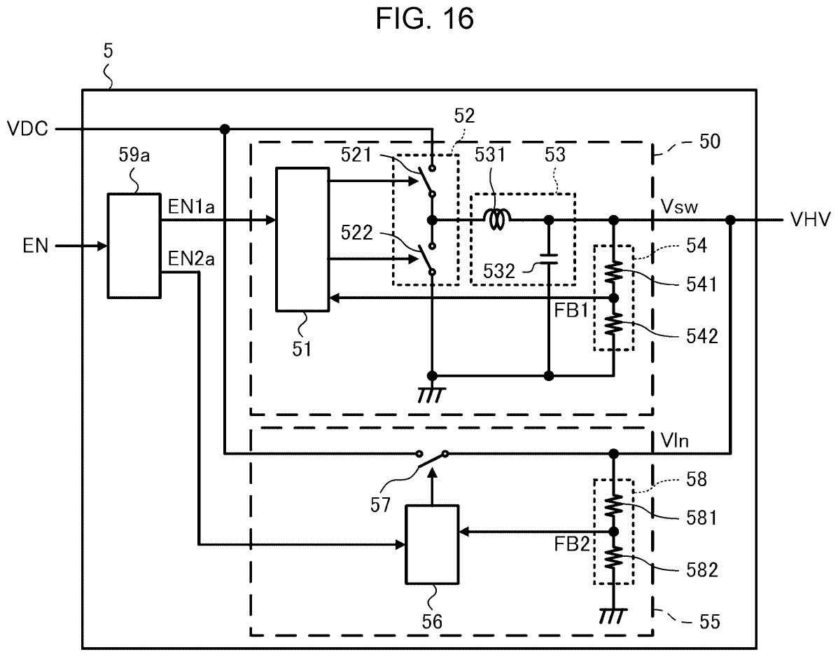

FIG. 16 is a diagram illustrating an example of a functional configuration of the power supply unit 5 included in the liquid ejecting apparatus 1 of the second embodiment. The liquid ejecting apparatus 1 of the first embodiment is described in which the control unit 2 outputs the output enable signals EN1 and EN2, and the power supply unit 5 controls the operation of the switching power supply circuit 50 according to the logic level of the output enable signal EN1 and controls the operation of the linear power supply circuit 55 according to the logic level of the output enable signal EN2 such that whether the voltage signal Vsw output by the switching power supply circuit 50 is output as the power supply voltage signal VHV or the voltage signal Vln output by the linear power supply circuit 55 is output as the power supply voltage signal VHV is switched. On the other hand, the liquid ejecting apparatus 1 of the second embodiment is different from the liquid ejecting apparatus 1 of the first embodiment in that the control unit 2 outputs the output enable signal EN, and the power supply unit 5 switches whether the voltage signal Vsw output by the switching power supply circuit 50 is output as the power supply voltage signal VHV or the voltage signal Vln output by the linear power supply circuit 55 is output as the power supply voltage signal VHV according to the logic level of the output enable signal EN.

As illustrated in FIG. 16, the power supply unit 5 of the second embodiment includes a power supply selection circuit 59a. The output enable signal EN output by the control unit 2 is input to the power supply selection circuit 59a. When the input output enable signal EN has an H-level, the power supply selection circuit 59a outputs an output enable signal EN1a having an H-level to the control circuit 51 included in the switching power supply circuit 50, and outputs an output enable signal EN2a having an L-level to the control circuit 56 of the linear power supply circuit 55. At this time, the switching power supply circuit 50 outputs the voltage signal Vsw, and the linear power supply circuit 55 does not output the voltage signal Vln. Therefore, the power supply unit 5 outputs the voltage signal Vsw output by the switching power supply circuit 50 as the power supply voltage signal VHV. On the other hand, when the input output enable signal EN has an L-level, the power supply selection circuit 59a outputs the output enable signal EN1a having an L-level to the control circuit 51 of the switching power supply circuit 50, and outputs the output enable signal EN2a having an H-level to the control circuit 56 of the linear power supply circuit 55. At this time, the switching power supply circuit 50 does not output the voltage signal Vsw, and the linear power supply circuit 55 outputs the voltage signal Vln. Therefore, the power supply unit 5 outputs the voltage signal Vln output by the linear power supply circuit 55 as the power supply voltage signal VHV.

The liquid ejecting apparatus 1 of the second embodiment configured as described above can also exhibit the same operational effects as those of the liquid ejecting apparatus 1 of the first embodiment.

### 3. Third Embodiment

Next, a liquid ejecting apparatus 1 of a third embodiment will be described. In describing the liquid ejecting apparatus 1 of the third embodiment, the same reference numerals are given to the same configurations as the liquid ejecting apparatus 1 of the first embodiment and the second embodiment, and the description thereof will be simplified or omitted.

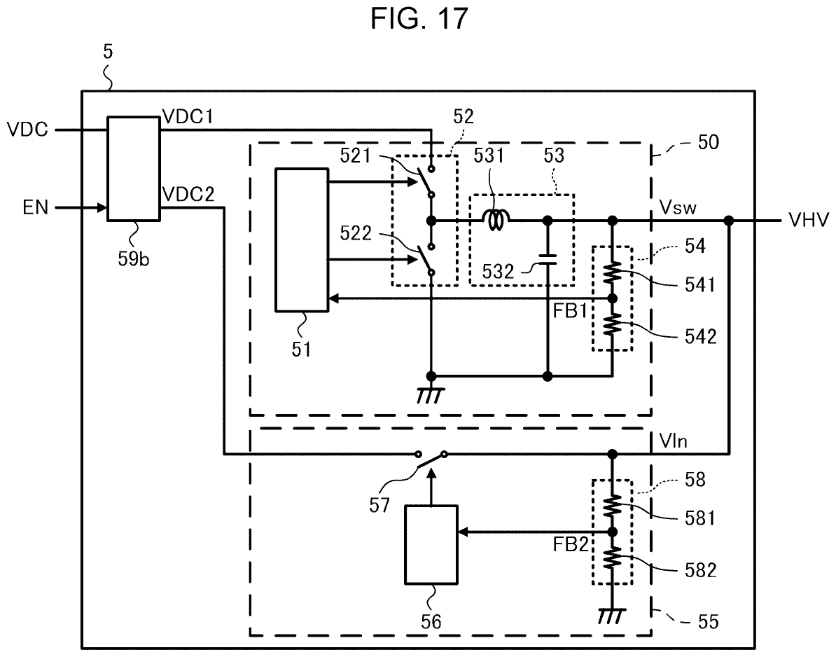

FIG. 17 is a diagram illustrating an example of a functional configuration of the power supply unit 5 included in the liquid ejecting apparatus 1 of the third embodiment. The liquid ejecting apparatus 1 of the third embodiment is different from the liquid ejecting apparatus 1 of the first embodiment in that the control unit 2 outputs the output enable signal EN, and the power supply unit 5 includes a power supply selection circuit 59b that switches whether or not to supply the power supply voltage signal VDC to the switching power supply circuit 50 as a power supply voltage signal VDC1 and whether or not to supply the power supply voltage signal VDC to the linear power supply circuit 55 as a power supply voltage signal VDC2 according to a logic level of the output enable signal EN.

As illustrated in FIG. 17, the power supply unit 5 of the third embodiment includes the power supply selection circuit 59b. The output enable signal EN output by the control unit 2 is input to the power supply selection circuit 59b. In addition, the power supply voltage signal VDC is also input to the power supply selection circuit 59b. When the input output enable signal EN has an H-level, the power supply selection circuit 59b supplies the power supply voltage signal VDC to the switching power supply circuit 50 as the power supply voltage signal VDC1, and supplies the power supply voltage signal VDC2 having a ground potential to the linear power supply circuit 55. At this time, the switching power supply circuit 50 outputs the voltage signal Vsw, and the linear power supply circuit 55 does not output the voltage signal Vln. Therefore, the power supply unit 5 outputs the voltage signal Vsw output by the switching power supply circuit 50 as the power supply voltage signal VHV. On the other hand, when the input output enable signal EN has an L-level, the power supply selection circuit 59b supplies the power supply voltage signal VDC1 having a ground potential to the switching power supply circuit 50, and supplies the power supply voltage signal VDC to the linear power supply circuit 55 as the power supply voltage signal VDC2. At this time, the switching power supply circuit 50 does not output the voltage signal Vsw, and the linear power supply circuit 55 outputs the voltage signal Vln. Therefore, the power supply unit 5 outputs the voltage signal Vln output by the linear power supply circuit 55 as the power supply voltage signal VHV.

The liquid ejecting apparatus 1 of the third embodiment configured as described above can also exhibit the same operational effects as those of the liquid ejecting apparatus 1 of the first embodiment.

### 4. Fourth Embodiment

Next, a liquid ejecting apparatus 1 of a fourth embodiment will be described. In describing the liquid ejecting apparatus 1 of the fourth embodiment, the same reference numerals are given to the same configurations as those of the liquid ejecting apparatus 1 of the first embodiment, the second embodiment, and the third embodiment, and the description thereof will be simplified or omitted.

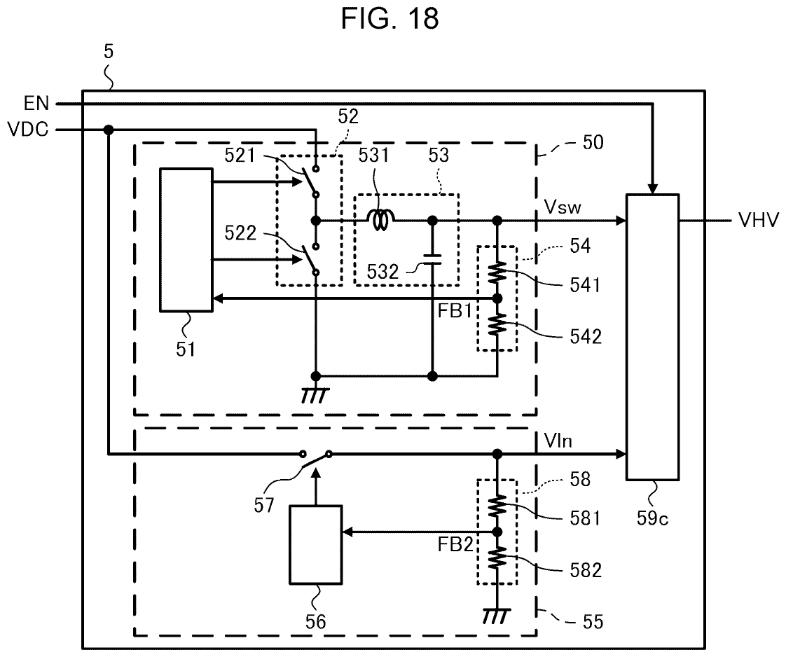

FIG. 18 is a diagram illustrating an example of a functional configuration of the power supply unit 5 included in the liquid ejecting apparatus 1 of the fourth embodiment. The liquid ejecting apparatus 1 of the fourth embodiment is different from the liquid ejecting apparatus 1 of the first embodiment in that the control unit 2 outputs the output enable signal EN, and the power supply unit 5 includes a power supply selection circuit 59c that switches whether to output the voltage signal Vsw output by the switching power supply circuit 50 as the power supply voltage signal VHV or to output the voltage signal Vln output by the linear power supply circuit 55 as the power supply voltage signal VHV according to a logic level of the output enable signal EN.

As illustrated in FIG. 18, the power supply unit 5 of the fourth embodiment includes the power supply selection circuit 59c. The output enable signal EN output by the control unit 2 is input to the power supply selection circuit 59c. Further, the voltage signal Vsw output by the switching power supply circuit 50 and the voltage signal Vln output by the linear power supply circuit 55 are input to the power supply selection circuit 59c. The power supply selection circuit 59c outputs the voltage signal Vsw output by the switching power supply circuit 50 as the power supply voltage signal VHV when the input output enable signal EN has an H-level, and outputs the voltage signal Vln output by the linear power supply circuit 55 as the power supply voltage signal VHV when the input output enable signal EN has an L-level.

The liquid ejecting apparatus 1 of the fourth embodiment configured as described above can also exhibit the same operational effects as those of the liquid ejecting apparatus 1 of the first embodiment.

### 5. Modification Examples

Here, in the present embodiment, the piezoelectric element PZ is described as being driven to eject the ink from the ejecting section D and outputting the signal according to the residual vibration generated in the ejecting section D. Meanwhile, the ejecting section D may have a configuration in which the piezoelectric element PZ as a driving element for ejecting an ink and the piezoelectric element PZ as a detection element for detecting residual vibration generated in the ejecting section D are individually included. In addition, at this time, the driving element for ejecting the ink in the ejecting section D is not limited to a piezoelectric element as long as the element can convert an electric signal into mechanical vibration, and the detection element for detecting the residual vibration generated in the ejecting section D is not limited to a piezoelectric element as long as the element can convert mechanical vibration into an electric signal.

In the present embodiment, the description is made on the assumption that the potential generated in the upper electrode Zu of the piezoelectric element PZ is output as a signal according to the residual vibration generated in the ejecting section D. Meanwhile, the potential generated in the lower electrode Zd of the piezoelectric element PZ may be output as a signal according to the residual vibration generated in the ejecting section D.

In addition, the signal according to the residual vibration generated in the ejecting section D may be a signal in which a current vibrates according to the residual vibration generated in the ejecting section D, or may be a signal in which a voltage vibrates according to the residual vibration generated in the ejecting section D. Therefore, the detection circuit 33 may be configured to detect a voltage value of the signal according to the residual vibration generated in the ejecting section D, or may be configured to detect a current value of the signal according to the residual vibration generated in the ejecting section D.

In addition, in the present embodiment, it is described that the signal waveform of the drive signal Com output by the drive signal output unit 4 is switched by the drive waveforms PP1 and PP2, the drive waveform PS, and the drive waveform PC, but the drive signal output unit 4 may individually include an amplifier circuit that outputs the drive waveforms PP1 and PP2, an amplifier circuit that outputs the drive waveform PS, and an amplifier circuit that outputs the drive waveform PC.

Hitherto, the embodiments and the modification examples are described. Meanwhile, the present disclosure is not limited to the embodiments, and can be implemented in various aspects within the scope not departing from the concept of the present disclosure. For example, the embodiments described above can also be appropriately combined with each other.

The present disclosure includes substantially the same configurations (for example, configurations having the same functions, methods, and results, or configurations having the same objects and effects) as the configurations described in the embodiments. Further, the present disclosure includes configurations in which non-essential parts of the configuration described in the embodiments are replaced. In addition, the present disclosure includes configurations that achieve the same operational effects or configurations that can achieve the same objects as those of the configurations described in the embodiments. Further, the present disclosure includes configurations in which a known technology is added to the configurations described in the embodiments.

The following contents are derived from the embodiments described above.

According to an aspect, there is provided a liquid ejecting apparatus including:
an ejecting section that ejects a liquid;
a residual vibration detection circuit that acquires a residual vibration signal according to residual vibration generated in the ejecting section and outputs a residual vibration detection signal according to the residual vibration signal;
a determination circuit that determines a state of the ejecting section according to the residual vibration detection signal;
a first switch circuit that switches whether or not to supply the residual vibration signal to the residual vibration detection circuit; and
a power supply circuit to which a first power supply signal is input and which outputs a second power supply signal to the first switch circuit, in which
the power supply circuit is configured to
   include a linear power supply circuit to which the first power supply signal is supplied and which outputs a first voltage signal, and a switching power supply circuit to which the first power supply signal is supplied and which outputs a second voltage signal, and
   output the first voltage signal or the second voltage signal as the second power supply signal.

In this liquid ejecting apparatus, the power supply circuit to which the first voltage signal is input and which outputs the second power supply signal to be supplied to the first switch circuit that switches whether or not to supply the residual vibration signal generated in the ejecting section to the residual vibration detection circuit includes the linear power supply circuit to which the first power supply signal is supplied and which outputs the first voltage signal, and the switching power supply circuit to which the first power supply signal is supplied and which outputs the second voltage signal. By outputting the first voltage signal or the second voltage signal as the second power supply signal, the power supply circuit can output the first voltage signal output by the linear power supply circuit, on which a ripple voltage is less likely to be superimposed, to the first switch circuit as the second power supply signal, in a period in which the first switch circuit supplies the residual vibration signal to the residual vibration detection circuit. Therefore, a possibility that the ripple voltage superimposed on the second power supply signal is superimposed on the residual vibration signal via the first switch circuit is reduced. Therefore, accuracy of the residual vibration signal corresponding to the residual vibration generated in the ejecting section acquired by the residual vibration detection circuit is improved, and accuracy of the residual vibration detection signal corresponding to the residual vibration signal output by the residual vibration detection circuit is improved. As a result, determination accuracy of the determination circuit that determines the state of the ejecting section in accordance with the residual vibration detection signal is improved. That is, accuracy of detecting the residual vibration is improved.

In the liquid ejecting apparatus according to the aspect, the first switch circuit may include a transistor element that switches whether or not to supply the residual vibration signal to the residual vibration detection circuit, and
the second power supply signal may be supplied to a back gate terminal of the transistor element.

In this liquid ejecting apparatus, the accuracy of detecting the residual vibration is improved. Therefore, the first switch circuit includes the transistor element that switches whether or not to supply the residual vibration signal to the residual vibration detection circuit, and the possibility that the second power supply signal is superimposed on the residual vibration signal via the first switch circuit is reduced even when the second power supply signal is supplied to the back gate terminal of the transistor element in order to improve the stability of the operation of the first switch circuit, and the accuracy of detecting the residual vibration is improved.

In the liquid ejecting apparatus according to the aspect, the first switch circuit may switch whether or not to supply the residual vibration signal to the residual vibration detection circuit based on a first selection signal according to the second power supply signal.

In this liquid ejecting apparatus, the accuracy of detecting the residual vibration is improved. Therefore, even when the first switch circuit switches whether or not to supply the residual vibration signal to the residual vibration detection circuit based on the first selection signal according to the second power supply signal, the possibility that the second power supply signal is superimposed on the residual vibration signal via the first switch circuit is reduced. Therefore, the accuracy of detecting the residual vibration is improved.

In the liquid ejecting apparatus according to the aspect, the power supply circuit may output the first voltage signal as the second power supply signal in a first period in which the first switch circuit supplies the residual vibration signal to the residual vibration detection circuit.

In this liquid ejecting apparatus, in the first period in which the first switch circuit supplies the residual vibration signal to the residual vibration detection circuit, the power supply circuit outputs the first voltage signal as the second power supply signal. Therefore, the possibility that the second power supply signal is superimposed on the residual vibration signal via the first switch circuit is reduced. Thus, the accuracy of detecting the residual vibration is improved.

In the liquid ejecting apparatus according to the aspect, the power supply circuit may output the second voltage signal as the second power supply signal in a second period in which the liquid is ejected from the ejecting section.

In this liquid ejecting apparatus, in the second period in which the liquid is ejected from the ejecting section, the power supply circuit outputs the second voltage signal as the second power supply signal. Thus, in a period in which the first switch circuit does not supply the residual vibration signal to the residual vibration detection circuit, a power consumption of the liquid ejecting apparatus can be reduced.

In the liquid ejecting apparatus according to the aspect, the linear power supply circuit may include a series regulator circuit.

In this liquid ejecting apparatus, the power consumption of the linear power supply circuit can be reduced.

In the liquid ejecting apparatus according to the aspect, the residual vibration detection circuit may include an AD conversion circuit and output the residual vibration detection signal of a digital signal.

In this liquid ejecting apparatus, the accuracy of detecting the residual vibration is further improved.

In the liquid ejecting apparatus according to the aspect, the ejecting section may include a piezoelectric element that is driven by a drive signal,
the liquid ejecting apparatus may further include
a second switch circuit that switches whether or not to supply the drive signal to the piezoelectric element, and
the second switch circuit may switch whether or not to supply the drive signal to the piezoelectric element based on a second selection signal according to the second power supply signal.

In the liquid ejecting apparatus according to the aspect, the residual vibration detection circuit may acquire an electromotive force generated by displacement of the piezoelectric element according to the residual vibration, as the residual vibration signal.

In the liquid ejecting apparatus according to the aspect, the ejecting section may eject the liquid by driving the piezoelectric element.

What is claimed is:

1. A liquid ejecting apparatus comprising:
an ejecting section that ejects a liquid;
a residual vibration detection circuit that acquires a residual vibration signal according to residual vibration generated in the ejecting section and outputs a residual vibration detection signal according to the residual vibration signal;
a determination circuit that determines a state of the ejecting section according to the residual vibration detection signal;
a first switch circuit that switches whether or not to supply the residual vibration signal to the residual vibration detection circuit; and
a power supply circuit to which a first power supply signal is input and which outputs a second power supply signal to the first switch circuit, wherein
the power supply circuit is configured to
include a linear power supply circuit to which the first power supply signal is supplied and which outputs a first voltage signal, and a switching power supply circuit to which the first power supply signal is supplied and which outputs a second voltage signal, and
output the first voltage signal or the second voltage signal as the second power supply signal.

2. The liquid ejecting apparatus according to claim 1, wherein
the first switch circuit includes a transistor element that switches whether or not to supply the residual vibration signal to the residual vibration detection circuit, and
the second power supply signal is supplied to a back gate terminal of the transistor element.

3. The liquid ejecting apparatus according to claim 1, wherein
the first switch circuit switches whether or not to supply the residual vibration signal to the residual vibration detection circuit based on a first selection signal according to the second power supply signal.

4. The liquid ejecting apparatus according to claim 1, wherein
the power supply circuit outputs the first voltage signal as the second power supply signal in a first period in which the first switch circuit supplies the residual vibration signal to the residual vibration detection circuit.

5. The liquid ejecting apparatus according to claim 1, wherein
the power supply circuit outputs the second voltage signal as the second power supply signal in a second period in which the liquid is ejected from the ejecting section.

6. The liquid ejecting apparatus according to claim 1, wherein
the linear power supply circuit includes a series regulator circuit.

7. The liquid ejecting apparatus according to claim 1, wherein
the residual vibration detection circuit includes an AD conversion circuit and outputs the residual vibration detection signal of a digital signal.

8. The liquid ejecting apparatus according to claim 1, wherein
the ejecting section includes a piezoelectric element that is driven by a drive signal,
the liquid ejecting apparatus further comprises
a second switch circuit that switches whether or not to supply the drive signal to the piezoelectric element, and
the second switch circuit switches whether or not to supply the drive signal to the piezoelectric element based on a second selection signal according to the second power supply signal.

9. The liquid ejecting apparatus according to claim 8, wherein
the residual vibration detection circuit acquires an electromotive force generated by displacement of the piezoelectric element according to the residual vibration, as the residual vibration signal.

10. The liquid ejecting apparatus according to claim 9, wherein
the ejecting section ejects the liquid by driving the piezoelectric element.
